(19) United States
(12) Patent Application Publication
(10) Pub. No.: US 2010/0064235 A1
(43) Pub. Date: Mar. 11, 2010

(54) Visual Intuitive Interactive Interwoven Multi-Layered Maintenance Support GUI

(76) Inventor: Marshall G. Walls, Fort Worth, TX (US)

Correspondence Address: CARSTENS & CAHOON, LLP, P O BOX 802334, DALLAS, TX, 75380, US

(21) Appl. No.: 12/548,295

(22) Filed: Aug. 26, 2009

Related U.S. Application Data
(60) Provisional application No. 61/190,069, filed on Aug. 26, 2008.

(51) Int. Cl. G06F 3/048

(52) U.S. Cl. 715/763

(57) ABSTRACT

A system and method for providing an interactive maintenance support GUI. The system provides a computing and related database device containing maintenance and support information related to a machine. The computing device provides a GUI for user interaction. The GUI has at least two areas for display of machine-related information, with one area providing greater information detail than the other. User movement of the GUI cursor with respect to area hot-spots causes the information to dynamically vary.

### CROSS-REFERENCE TO RELATED APPLICATIONS

This application claims the benefit of provisional Application No. 61/190,069, filed Aug. 26, 2008.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a computer based system for assisting a technician in performing maintenance and repair operations.

2. Description of Related Art Including Information Disclosed Under 37 CFR 1.97 and 1.98

Complex machinery typically requires substantial amounts of maintenance and repair and because of the complexity involved; technicians skilled in performing such operations can be quite costly. Further, most complex equipment incorporates mechanical, electrical, and computer components which confounds the issue further. Such equipment may require multiple technicians to accomplish even the simplest of repairs.

Such complex equipment having multiple sub-assemblies and components also requires numerous volumes of manuals that can be difficult to store, retrieve, and access. These manuals tend to be relatively “unfriendly” in terms of usability for all but the highest of skilled technicians. Also, unless the manuals are maintained current, they can sometimes become out of date and not provide the latest in troubleshooting tips and available part numbers. Moreover, the real estate required to house this library of manuals only adds to the overall expense.

For example, a basic high-speed mail sorter with the U.S. Postal Service (USPS) can have hundreds of mechanical electrical, and computer control sub-systems. These sub-systems must be perfectly synchronized to properly sort the tremendous volume of mail that the USPS processes daily. Often, a failure in one sub-system is difficult to trace when considering only the overall symptoms. A repair technician must consult numerous volumes of manuals and perform detailed, exacting steps to isolate the problem and, once isolated, must properly calibrate the transport and sorting mechanisms.

In the past, an “inside-out” approach to maintenance/training has been used. This inside-out approach required leader-led training, computer based training, self-study, maintenance documentation, parts ordering knowledge, and years on the job experience to attain an expert level of knowledge of a complex machine. The inside-out approach concentrated on how the machine did what it did. Such training techniques are costly in both time and expense.

What is needed is a repair system that allows a relatively unskilled technician to perform maintenance and repairs on complex machinery. Also needed is a means for providing equipment maintenance and repair manuals that is easy to support and update. The present invention satisfies these needs and others as shown by the detailed description below.

### BRIEF SUMMARY OF THE INVENTION

A method is disclosed for providing a user with dynamically varying levels of operational, support, maintenance, and repair information for a machine or piece of equipment composed of a plurality of subcomponents, the method steps comprising: providing a database device capable of supplying detailed information regarding a machine, and a first computing device operably coupled with the database device and operably configured to provide a graphical user interface (GUI) capable of user interaction, the GUI providing a cursor for manipulation by a user and at least a first area and a second area for display of information detail regarding the machine, the first area and second area including one or more hot-spots for user interaction, wherein the information in the areas is related, and wherein the detail level of the related information varies between the areas; providing a first image of the machine in a first window area on the GUI wherein the first image represents a high-level image of the machine; displaying a first level of information detail related to the operation of the machine; and detecting the cursor position and varying the information displayed in the first area or the second area based upon the cursor position and, in response, displaying a second level of information detail that is greater in detail than the first level of information.

A computer implemented interactive machine maintenance support system is disclosed, the system comprising: a database device capable of providing detailed information regarding a given machine; a first computing device operably coupled with the database device and operably configured to provide a graphical user interface (GUI) capable of user interaction, the GUI comprising: a first area for displaying a first level of information detail regarding the machine, the first area including one or more hot-spots for user interaction; and a second area for displaying a second level of information detail that is greater in detail than the first level of information detail provided in the first area, wherein the second level of information is related to the first level of information, the second area including one or more hot-spots for user interaction; wherein a user may interact with a hot-spot by manipulating a cursor with respect to the first or second area hot-spots, wherein manipulation of the cursor occurs through manipulation by the user of an input device, and wherein interaction with a hot-spot in one area influences the information displayed in the other area.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 depicts the simplified navigation diagram for the present invention;

FIG. 2 depicts a homepage display;

FIG. 3 depicts the homepage display with the cursor over the Unit 1 hot-spot;

FIG. 4 depicts the homepage display with the cursor over the Unit 2 hot-spot;

FIG. 5 depicts a display with the cursor over the OBD button's hot-spot;

FIG. 6 depicts the Lane Motors Control DBD window display with no active Cursor Windows;

FIG. 7 depicts the Lane Motor Control DBD window display with active Cursor Windows;

FIG. 8 depicts the Unit 1 Control Computer's window display with no active Cursor Windows;

FIG. 9 depicts the Unit 1 Control Computer's window display with an active Cursor Window;

FIG. 10 depicts the Unit 1 Control Computer PCB blocked schematic window display with no active Cursor Windows;

FIG. 11 depicts the Unit 1 Control Computer PCB blocked schematic window display with the cursor over the J2 hot-spot;

FIG. 12 depicts an OBD window display;

FIG. 13 depicts the cursor over the OBD's System Jam Monitor Circuit's hot-spot;

FIG. 14 depicts the cursor over the OBD Lane Motor Control's hot-spot;

FIG. 15 depicts the Lane Motor Control Circuit IBD window display;

FIG. 16 depicts the cursor over the Lane Motor 1R and 1L's hot-spot;

FIG. 17 depicts the Lane Motor Control DBD's window display;

FIG. 18 depicts the cursor over the Signal Link System Control Data's hot-spot;

FIG. 19 depicts the Diverter Control Circuits IBD's window displays;

FIG. 20 depicts the cursor over the System Control Data's signal hot-spot;

FIG. 21 depicts the Lane Motor Control DBD's window displays;

FIG. 22 depicts the cursor over the System Control Data Signal Link's hot-spot;

FIG. 23 depicts the Diverter Control DBD's window display;

FIG. 24 depicts the cursor over the System Control Data Signal's hot-spot;

FIG. 25 depicts the cursor over Unit 1's hot-spot;

FIG. 26 depicts Unit 1's window displays;

FIG. 27 depicts the cursor over Unit 1 Lane Motor 1R's hot-spot;

FIG. 28 depicts the cursor over the R&R Lane Motor Button's hot-spot;

FIG. 29 depicts the Lane Motor R&R's window displays with the cursor over the Comply button's hot-spot;

FIG. 30 depicts the Lane Motor R&R Procedure cursor over Step 1's hot-spot;

FIG. 31 depicts the cursor over J1/P1 Connector's hot-spot;

FIG. 32 depicts the cursor over the Signal LA's hot-spot;

FIG. 33 depicts the Relay Logic Panel A schematic display;

FIG. 34 depicts the cursor over the Relay Logic Panel A's hot-spot;

FIG. 35 depicts the cursor over the Signal LA's hot-spot;

FIG. 36 depicts the J1/P1 Connector's schematic displays;

FIG. 37 depicts the cursor over the Troubleshooting button's hot-spot;

FIG. 38 depicts the Troubleshooting Symptom window display;

FIG. 39 depicts the cursor over the Troubleshooting Symptom's hot-spot;

FIG. 40 depicts the cursor over the R&R Lane Motor button's hot-spot;

FIG. 41 depicts the Lane Motor R&R Procedure window display;

FIG. 42 depicts the cursor over the Belting button's hot-spot;

FIG. 43 depicts the Belting Overall Diagram window display;

FIG. 44 depicts the cursor over Belt 1R's hot-spot;

FIG. 45 depicts the Lane Belt 1R DMD window display;

FIG. 46 depicts the cursor over 1R's Electro-Mechanical Connection to Lane Motor 1R display;

FIG. 47 depicts the cursor over the next unit link's hot-spot;

FIG. 48 depicts Unit 2's window display;

FIG. 49 depicts the cursor over the next unit's hot-spot;

FIG. 50 depicts Step 2 of the Lane Motor's R&R Procedure window display;

FIG. 51 depicts Step 9 of the Lane Motor's R&R Procedure window display;

FIG. 52 depicts Step 6 of the Lane Motor's R&R Procedure window display;

FIG. 53 depicts the Stop-and-Go Animation Step 1 window display;

FIG. 54 depicts the Stop-and-Go Animation Step 2 window display;

FIG. 55 depicts the Stop-and-Go Animation Step 3 window display;

FIG. 56 depicts the Stop-and-Go Animation Step 4 window display;

FIG. 57 depicts the Stop-and-Go Animation Step 5 window display;

FIG. 58 depicts the Stop-and-Go Animation Step 5 frozen window display;

FIG. 59 depicts the Stop-and-Go Animation Step 5 frozen window with active Cursor Window displays;

FIG. 60 depicts the cursor over Unit 1 Control Computer's hot-spot;

FIG. 61 depicts the cursor over the UCC Block Diagram button's hot-spot;

FIG. 62 depicts the Unit 1 Control Computer PCB's Blocked Schematic window display;

FIG. 63 depicts the cursor over the Lane Control Circuit's hot-spot;

FIG. 64 depicts the cursor over the UCC Block Schematic button's hot-spot;

FIG. 65 depicts the cursor over the Order Lane Motor button's hot-spot;

FIG. 66 depicts the Lane Motor's Order Form window display;

FIG. 67 depicts the Lane Belt 1A Detailed Mechanical Diagram (DMD) window display;

FIG. 68 depicts the cursor over 1R's Mechanical Signal connection;

FIG. 69 depicts the Lane Motor Control DBD's window display;

FIG. 70 depicts the cursor over Mechanical Signal Link Triangle 1R's hot-spot;

FIG. 71 depicts the Lane Belt 1A DMD's cursor over Lane Drive Bearing Block Assembly's hot-spot;

FIG. 72 depicts the Lane Drive Bearing Block Assembly's DMD display; and

FIG. 73 depicts the Management Software structure diagram.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Certain terms used herein are defined as follows:

| Component | Description |
|---|---|
| Active-window | The large window currently displayed is referred to as the active-window. |
| Item-of- | Complex item-of-interests require more information to describe their location and |
| interests- | functions than simple item-of-interests. Complex item-of-interests usually perform more |
| Complex | than one function in one replaceable part. Complex items-of-interest can require an |
| | associated schematic or other types of technical information to describe them and their |
| | relationship with machine operations. Printed Circuit Boards with multiple circuits is an |
| | example of a complex item-of-interests. |
| Item-of- | These item-of-interests usually perform only one machine function. Some examples of |
| interests- | simple item-of-interests are motors, solenoids, and solid state relays with a dedicated set |
| Simple | of contacts. |
| Cursor | A device, such as a pointer, that moves around a computer display in response to some |
| | external movement. On a touch screen the cursor can be anything used to touch the |
| | screen, like a human finger, or pencil eraser. Typical cursors are controlled by a mouse, |
| | rollerball, joy stick, or similar input device. The cursor may change shape when over a |
| | hot-spot. In an immersive environment such cursor may be a haptic interface device, |
| | such as a glove that is capable of interaction with the environment, wherein the user |
| | wearing the glove may point to various objects in the environment. |
| Cursor Window | Cursor windows display information in relationship with cursor position. Hot-spots are |
| | placed over items-of-interest. When the cursor is over an item-of-interest's hot-spot a |
| | mouse-over action occurs and detailed information about the item-of-interest is displayed |
| | in the associated Cursor Window/windows. This information provides The user with |
| | enough information to decide if this is the navigational route The user wants to take. The |
| | cursor-windows have two frames. Only one frame is active at any time. When the |
| | cursor isn't over a hot-spot (cursor-window not active) the black frame is displayed. |
| | When the cursor is over an item-of-interest's hot-spot the dashed yellow/black Line |
| | (Working Area Frame) is displayed around the active Cursor Windows. There can be as |
| | many Cursor Windows as necessary on the active-window. The main purpose of the |
| | Cursor Windows is to give The user enough information to make the decision whether to |
| | click and drill into an item-of interest or to move the cursor to another item-of-interest. |
| | The secondary purpose of the Cursor Windows is to provide the user with detailed |
| | information associated with the item-of-interest the cursor is over. There can be as many |
| | Cursor Windows as necessary. The Cursor Windows can be different sizes and |
| | positions. |
| Cursor-position | The position that the cursor is at on the active-window. Cursor position changes as the |
| | cursor moves around the active-window. |
| Detailed Block | Each function or circuit has its own DBD and IBD. DBDs have multiple windows. The |
| Diagram (DBD) | DBDs have signal links that are used to follow that DBD's signals from DBD window to |
| | DBD window. DBDs also have signal links to navigate from one DBD circuit to another |
| | DBD circuit. The DBDs also have level links to move from the DBD item-of-interest to |
| | that item-of-interest on the IBD. DBD's show item-of-interest information using |
| | schematics. |
| Detailed | A window that displays mechanical information. Usually has mechanical connections |
| Mechanical | (triangle) to other driving or driven devices. |
| Diagram (DMD) | |
| GUI The | The GUI provides multiple methods to locate detailed machine maintenance information. |
| (Graphic User | The user can locate the detailed maintenance information about any item-of-interest in |
| Interface) | question by navigating into The GUI by: |
| | The item-of-interests Physical Appearance and Location entrance. |
| | The user knows where the item-of-interest is located and what it looks |
| | like (its physical appearance). The user navigates to the item-of-interest |
| | by using pictures of the machine. |
| | What function an electrical item-of-interest does in an electrical circuit (Overall |
| | Block Diagram) entrance. |
| | The user knows what the machine is not doing, i.e. Not running product |
| | because of repeated jams in Unit 1 because a Lane Motor isn't working. |
| | The user can locate detailed information about the faulty Lane Motor by |
| | going to the Overall Block Diagram and selecting the Lane Motors |
| | Control circuit. |
| | What function a mechanical item-of-interest does (Belting) entrance. |
| | The user knows what the machine is not doing, i.e. Not running product |
| | because of repeated jams in Unit 1. After visual examination, it is |
| | determined that a belt is broken, causing the product to jam. The user |
| | can locate detailed information about the missing belt by navigating |
| | down through the Overall Belting Diagram. |
| | What symptom (Trouble Shooting) the item-of-interest creates when not working |
| | to specification entrance. |
| | The user knows what the machine is not doing, i.e. Not running product |
| | because of repeated jams at the same spot. The user can locate |
| | detailed information about the symptom by going to Trouble Shooting |
| | and selecting the symptom from a list of symptoms. The user then |
| | follows a trouble shooting procedure to resolve the fault. |
| Hot-Spots | Hot-Spots are located over items-of-interest. When the cursor is over a hot-spot, |
| | information associated with the item-of-interest is displayed in Cursor Windows and |
| | dashed yellow/black dashed line Working Area Frames display around the active Cursor |
| | Windows. The yellow and black dashed lines frame the associated Cursor Windows |
| | during mouse-overs. |
| Information- | The information packing design anticipates what the user is looking for and packs the |
| Packing ™ | surrounding area with related information. Information Packing is a design concept that |
| | uses the cursor, hot-spots, and Cursor Windows to pack information around items-of- |
| | interest. The designer knows what the items-of-interest are on a window. Hot spots are |
| | then placed over the items-of-interest and more detailed information about the item-of- |
| | interest is placed in the associated Cursor Windows. The information in the Cursor |
| | Windows isn't displayed until the cursor is moved over the item-of-interest's hot-spot. |
| | When the cursor is over an item-of-interest's hot-spot, the detailed information about the |
| | item-of-interest is displayed in Cursor Windows. The information displayed can be any |
| | form of multi-media, such as pictures, text, audio, video, line art, etc. To navigate to more |
| | information about the item-of-interest click on the hot-spot. |
| Intermediate | The IBDs have signal links to follow signals to and from other IBDs. The IBDs also have |
| Block Diagram | level links to move from the IBD item-of-interest to the item-of-interests DBD. |
| (IBD) | |
| Items-of- | The items-of-interest can be any point on the screen i.e. item-of-interests, buttons, |
| interest | arrows, letters, shapes, pictures, text, numbers, colors, areas of the screen, etc. and are |
| | marked with a hot spot. The item-of-interest usually has associated Cursor Windows and |
| | links to more detailed information. |
| | Items-of-interest don't always have links. In this case, if there is no more information |
| | required for the item-of-interest the cursor is over more information isn't needed. |
| Job Aide | Automatically filling out the parts ordering form, etc. |
| Layers | Overall, Intermediate, and Detailed. |
| Link - | Hardware Links: Unit window link to the next unit link. Usually used in a right left manner. |
| Hardware | Symbol is an arrow head, pointing in the direction the link will carry the user. Typically |
| | called Right Unit Arrow (pointing to the right) or Left Unit Arrow (pointing to the left). |
| Link - Signal | AKA Stepping Stones are used to follow signal paths through multiple window diagrams. |
| Link - Look- | The signal link has a Hot Spot. When the cursor passes over the Hot Spot information |
| ahead link | about where the signal/signals goes is displayed in the Cursor Windows. |
| Link - Look- | Signal links are used to follow signals from one window to another. This includes DBD to |
| behind-link | DBD and IBD to IBD. There are no signal links from DBD to IBD or IBD to DBD. |
| (Signal Links) | |
| Links | Types of links are; Level, hardware, signal, and complex. |
| | Also Quiz and Test links? |
| Links - Level | Level Links are used to make navigating The GUI from one level to the next easy. Some |
| | examples of level links are ODB to IBD, IBD to DBD, and DBD to IBD. |
| Links - | Mechanical links connect the driving item-of-interest i.e. Lane Motor to the driven item-of- |
| Mechanical | interest, the driven pulley. The mechanical link features a dashed line with a triangle at |
| | the end. The triangle has the drive item-of-interests reference inside it. The triangle is |
| | pointed towards the drive element. During mouse-over the triangle is displayed as yellow |
| | and black dashed lines. In this example the triangle is pointing towards the motor R1. |
| | [symbol] |
| Management | The Management Software (MS) tracks the user's activity and parts usage. The MS |
| Software | monitors the user's activities and creates detailed reports for management's evaluation. |
| | The MS also records parts usage, including the location of faulty parts, that parts |
| | replacement history, etc. The MS records the parts used, time it takes to replace the part |
| | and the time it should take to replace the part. Put a note function on the parts ordering |
| | form so that detailed information about the part can be recorded. |
| Mouse-Over- | Mouse-over-action occurs when the cursor is over a hot-spot. During a mouse-over- |
| Action | action dashed yellow/black Working Area Frames display around active Cursor |
| | Windows. |
| Moving Shape | A Moving Shape is sometimes used to point-out items-of-interest, during a mouse-over, |
| | inside of a Cursor Window (Working Area Frame) to the user. Sometimes multiple |
| | shapes (Boxes, Circles) are used to point out items-of-interest. The shape of the Moving |
| | Shape can vary depending on the shape of the item-of-interest. The Moving Shape is |
| | usually white, but can be of any color, shape, or size. |
| Multi-Layered | The three diagram levels are; overall, Intermediate, and detailed. The levels are |
| Diagrams | designed to enable the user to move from a high visual and functional level through a |
| | circuit functional understanding level to a maintenance support or detailed level. The |
| | Overall Block Diagram is designed to get the user to the right circuit or function. To do |
| | this the OBD uses text, visual images of the machine, and a functional circuit layout that |
| | the user can relate to. The functional layout relates to what the machine does, allowing a |
| | user with no technical training on the machine to trouble shoot at an expert level.. The |
| | Intermediate Block Diagrams (IBD) and Detailed Block Diagrams (DBD) work together to |
| | make understanding and troubles shooting complex circuits or functions quick and easy. |
| | The IBD is a high level diagram that shows relationships between item-of-interests in a |
| | circuit or function, the DBD shows technical details about the item-of-interests in a circuit |
| | or function. The IBD is typically a one window Block Diagram but can require multiple |
| | windows. IBDs have electrical and/or mechanical signal connections to other circuits or |
| | functions IBDs. A DBD typically has multiple windows, but can be only one window. |
| Operational | A user with knowledge of how the machine operates and some technical experience. |
| User | |
| Overall Block | The highest level diagram. The OBD usually requires only one window, but complex |
| Diagram (OBD) | systems can require multiple window OBDs. Unlike the IBDs and DBDs the OBD shows |
| | all of the systems circuits or functions. The OBD provides links from each circuit or |
| | function to that circuit or function's IBD. Each circuit or function has its own IBD and |
| | DBD. |
| Stop & Go | Stop and Go animation (SGA) uses colors to focus on segments of complex circuits. In |
| Animation | this example white, red, and yellow are used to explain the operation of a complex |
| (Stop-and-Go | circuit. The colors break the circuit up into associated chunks. SGA is designed to |
| Animation) | display circuit operations as it relates to time and/or events. The white color is used to |
| | represent portions of the circuit not explained yet. The red color represents the current |
| | portion of the circuit of interest. The yellow color represents portions of the circuit already |
| | explained. |
| | SGA is divided into a sequence of events referred to as steps. When the cursor is over |
| | the steps (numbers) the window changes to focus on that step. The best way to learn |
| | using SGA is to start at step 1 and continue to the last step, in this case step 5, but SGA |
| | allows the user to review the steps in any order. |
| | SGA has two distinct modes. The first mode uses mouse-overs to display circuit |
| | operation information associated with that step. The first mode has a Freeze Window |
| | feature. When a circuit operation step is clicked on, the window enters the frozen mode. |
| | This mode freezes the window, allowing the user to navigate around the frozen window |
| | using mouse-overs and links. |
| | The user controls the movement of the cursor. When moving the cursor over the circuit |
| | operation numbers the window changes. When the cursor is over a number the |
| | associated circuit is displayed as red. The user usually starts at the number 1 and moves |
| | the cursor over the numbers until the item-of-interest is located. The user can click on |
| | any number to freeze the window. |
| Stop & Go | Stop and Go video mimics the time-sequence of video frames, but provides The User |
| Video | with much more control of the frame rate and direction. Some of the benefits of stop-&- |
| (Stop-and-Go | Go video is the ability to access any frame (step) in the video, watch the frame (step) for |
| Video) | as long as needed, move forward and backward as needed, access the steps in any |
| | order. Stop & Go Video is an efficient way to review and learn about many types of |
| | complex subjects. In this example a Removal and Replacement (R&R) procedure is |
| | used. |
| | Stop and Go video mimics the time-sequence of video frames, but provides The User |
| | with much more control of the frame rate and direction. Some of the benefits of stop-&- |
| | Go video is the ability to access any frame (step) in the video anytime, watch the frame |
| | (step) for as long as needed, move forward and backward as needed, etc. Most steps |
| | presented in Stop & Go Videos have mouse-over action, but do not have a link because |
| | there is no more information available for that item-of-interest. |
| Student Mode | The student must complete The User training before having access to the GUI. |
| | In the Student Mode the parts ordering function is disabled. |
| System | Any type of hardware or software that performs a function or task. Systems can be of |
| | unlimited size and complexity having many functions or tasks, but can also be very small |
| | performing only one function or task. |
| Systems | The Systems Management Software (SMS) monitor multiple systems The User's activity |
| Management | and maintains parts usage records. The SMS monitors The User's activities and creates |
| Software | detailed reports for management's evaluation for multiple machines/systems. The SMS |
| | also records parts usage, including the location of faulty parts, that parts replacement |
| | history, etc. for multiple machines/systems. The SMS records the parts used, time it |
| | takes The User to replace the part and the time it should take to replace the part for |
| | multiple machines/systems. The SMS also outputs detailed reports of user's activity and |
| | parts usage for multiple machines/systems. |
| Technical User | A user with technical experience or training and some operational experience with the |
| | machine. |
| Technician | After finishing The User Training course, the User can access all aspects of The GUI.. |
| Mode | |
| Trouble | Symptoms are listed in alphabetical order. When mouse-over the symptom list a Cursor |
| Shooting | Window displays the trouble “cause” information associated with the symptom. When the |
| | user, using the symptom list and the information displayed in the Cursor Window/s, |
| | locates the trouble (cause) in the symptom list the user should click on the symptom to |
| | go to more detailed trouble shooting information related to the cause. |
| Working Area | Yellow/black dashed lines make up a Working Area Frames. Working Area Frames are |
| Frames | displayed during mouse overs. |

The Visual Intuitive Interactive Interwoven Multi-Layered Maintenance Support Graphical User Interface (GUI) of the present invention uses sophisticated information-packing techniques that enable both operational and technical users to locate non-obvious detailed maintenance support information easily without any prior machine specific technical training or maintenance documentation. The system utilizes information-packing to make virtually an unlimited number of pages of information available to the user on one window. It is not uncommon to have more than 100 pages of related information available to the user in a single window.

Unlike previous technical information accessing systems (books, hardcopy, web based training, computer base training, etc.) that move from one page or window to another in a linear fashion, the GUI of the present embodiment relies on visual information to stimulate intuitive interactions with both operational and technical users alike.

Operational and technical users are familiar with what a given machine does and how it operates. For example, a particular machine may print checks and address information on envelopes. The machine then inserts the checks into the envelopes and then sorts the envelopes according to the address into plastic bins. How the inner workings of the machine function may not be readily apparent, but what the machine does is obvious to the user that has observed the machine during operations.

The GUI employs an outside-in approach to locating detailed technical information by using the machine's visual appearance and operations (functions) to lead the user to detailed non-obvious technical information. Learning how to use the GUI to locate detailed maintenance information turns a machine novice into a machine expert in a relatively short amount of time.

The GUI also tracks the users and creates detailed user and machine related records, makes parts fulfillment quick and easy by automatically providing all the information needed to order parts, saves parts usage information to the data base (tracks every part on the machine by the parts unique location). The information saved to the data base also allows for parts failure trends to be recorded and analyzed.

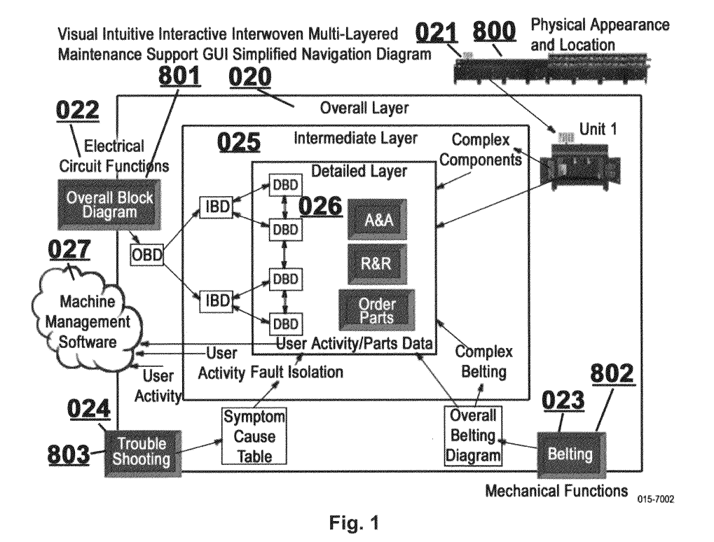

The GUI of the present embodiment displays equipment (or machine) operations and maintenance support information (pictures, text, line art, etc) in multiple layers, beginning with an Overall Layer (020) as depicted in FIG. 1. The overall layer displays information of interest to both operational and technical users alike, and includes the Physical Appearance and Location of the equipment under scrutiny to provide a reference point (021), the machine's electrical circuit function Overall Block Diagram (OBD) (022), a Belting Diagram (Mechanical Functions) (023), and Trouble Shooting details (024) (machine fault symptoms).

The GUI operates as a conventional user interface that allows the user to select, or “click,” an onscreen link to perform a particular function. Clicking on one of the options at the Overall Layer (020) “drills down” to the Intermediate Layer (025). The Intermediate Layer (025) displays machine maintenance information in additional detail. The user may “drill down” further, from the Intermediate Layer (025) to the Detailed Layer (026). The Detailed Layer (026) contains all maintenance information necessary to support the given overall piece of equipment. This detailed information includes, but is not limited to, Detailed Block Diagrams (schematics); Removal & Replacement Procedures; Adjustment & Alignment procedures; parts ordering forms, and all other maintenance tasks and information required to support and maintain the machine. The Management Software (027) monitors any machine maintenance activities.

### Cursor Windows

The present embodiment utilizes Cursor Windows to display information related to the position of the cursor. Cursor Windows interact with the cursor, items-of-interest, and hot-spots to display detailed information about the item-of-interest. Hot-spots are created over items-of-interest. Items-of-interest are usually machine components that are associated with machine operation. In this embodiment, multiple items-of-interest exist on a particular window. Each item-of-interest has one or more hot-spots. When the cursor is placed over such a hot-spot, a mouse-over action causes detailed information related to the item-of-interest to be displayed in the associated one or more Cursor Windows.

Each Cursor Window has two frames, with only one frame active at any given time. When the cursor isn't over a hot-spot the associated Cursor Window/Windows are considered inactive and a black frame is displayed around the window. However, when the cursor is positioned over a hot-spot (i.e., item-of-interest), a dashed yellow/black Working Area Frame is displayed around the associated active Cursor Windows. Thus, the presence of the Working Area Frame indicates that the cursor is over additional information that is related to the base information being displayed in the active Cursor Window.

In the present embodiment there can be as many Cursor Windows, of same or different physical dimension, as necessary to communicate the pertinent technical information the user needs to know about an item-of-interest. The Cursor Windows is intended to provide the user enough information to make the decision of whether or not to select and navigate into the item-of-interest.

### Cursor Window Example 1

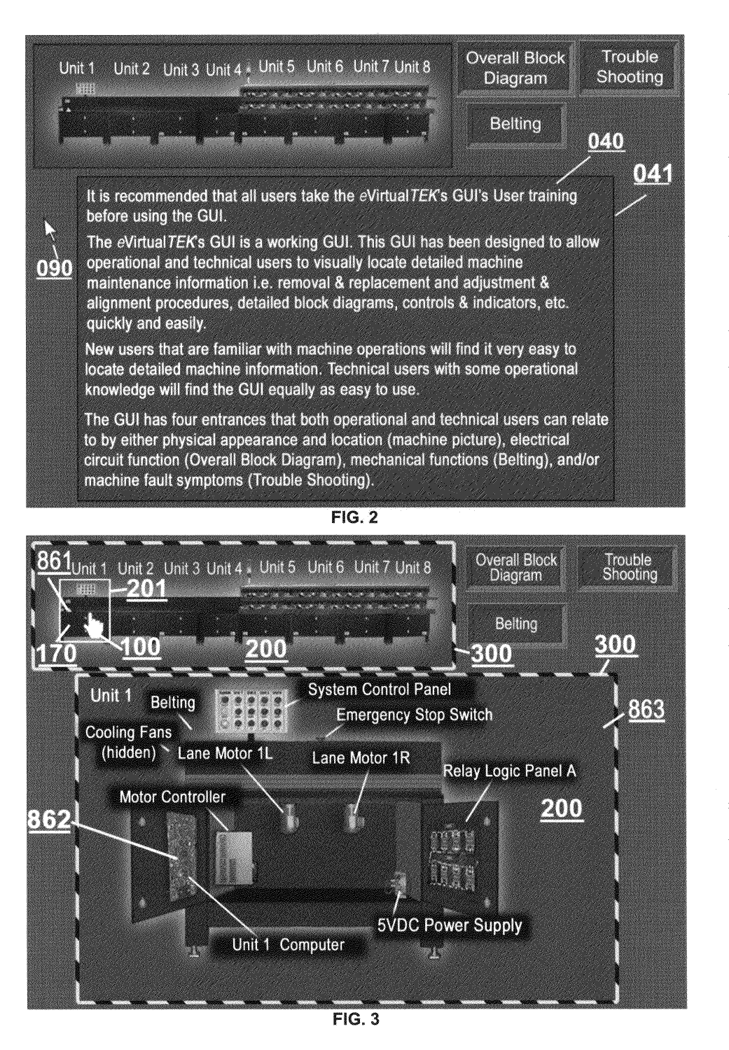

FIG. 2 depicts a typical inactive Cursor Window. The home page is displayed with a non-mouse-over cursor (090). No active Cursor Windows (Working Area Frames) are shown, because the cursor (090) is not positioned over an item-of-interest's hot-spot. Accordingly, the Cursor Window (040) is not active and a black frame is displayed (041).

FIG. 3 depicts an active Cursor Window. In this figure, the cursor (100) is positioned over Unit 1's hot-spot (170). In this embodiment when over the hot-spot (170), the cursor shape changes from the non-mouse-over cursor (arrow) to the mouse-over-cursor (pointing hand). Such a change in cursor shape provides an additional queue to the user that a hot-spot is present. With the cursor (100) in this position the Cursor Windows (200) are framed with yellow and black dashed Working Area Frames (300).

The Working Area Frames (300) frame Cursor Windows that are displaying detailed information related to the item-of-interest beneath the cursor. As depicted, Unit 1 has the access doors open, showing Unit 1's internal items-of-interest. If the user wants to know more about Unit 1, clicking on Unit 1 causes a window to be displayed, providing additional detailed information about Unit 1. A white Moving Shape Box (201) is used to pinpoint an item-of-interest, in this case Unit 1 inside of the Cursor Window's Working Area Frame. Thus, Unit 1 of the machine depicted at the top of the GUI is essentially highlighted, magnified, and exploded in the Cursor Window near the bottom of the GUI to provide greater detail.

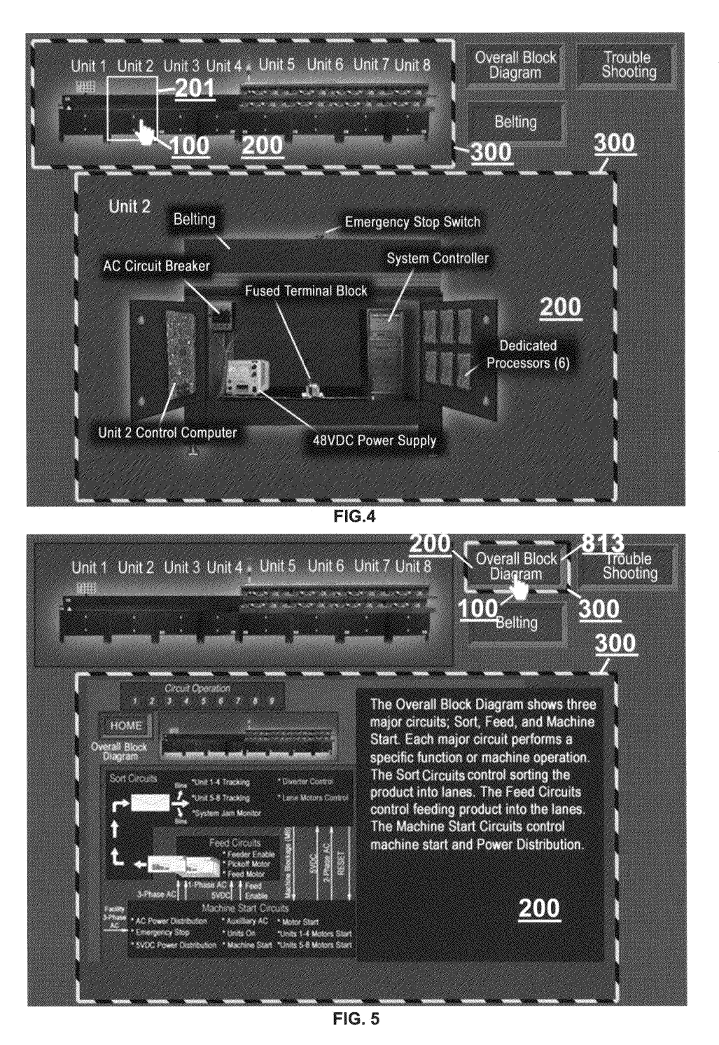

FIG. 4 provides a depiction of the active Cursor Window. As shown, the cursor 100 is now positioned over Unit 2's hot-spot (201). In response, the associated Cursor Windows (200) are framed with yellow and black dashed Working Area Frames (300). The Working Area Frames (300) highlight detailed information related to Unit 2. As depicted, the lower Cursor Window features a close-up view of Unit 2 with its access doors open, showing the internal details. If the user wishes to learn more about Unit 2 internals, he or she need only click on the Unit 2 image to display a window providing more detailed information. A white Moving Shape Box (201) highlights the item-of-interest's location on the main equipment depicted near the top of the GUI. In this instance, Unit 2 is selected as shown inside of the Cursor Window's Working Area Frame.

In FIG. 5 the cursor (100) is depicted as having been placed over the Overall Block Diagram button. Again, the associated Cursor Windows (200) are framed with yellow and black Working Area Frames (300). The Working Area Frames (300) highlight information related to the item-of-interest which, in this case, is the Overall Block Diagram button. This provides the user with information to assist in deciding whether or not to click on the button or to continue to look for more information by moving the cursor over other items-of-interest on the window.

### Cursor Window Example 2

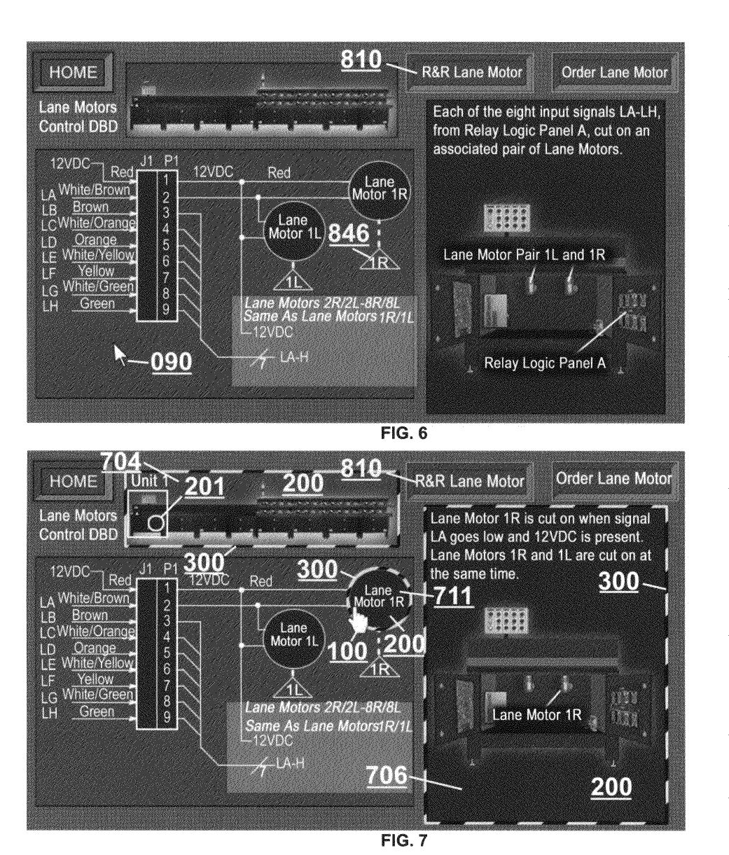

In FIG. 6, the Lane Motors Control DBD window is displayed. As shown, no Cursor Windows are active and the non-mouse-over cursor (090) is displayed. When the user positions the cursor over a designated hot-spot, the information changes as depicted in FIG. 7. As depicted, the cursor (100) is positioned over the Lane Motor 1R's hot spot. The Cursor Windows are framed with yellow and black dashed Working Area Frames (300). The Working Area Frames (300) highlight related information—in this case Lane Motor 1R. Two Moving Shapes (201), a circle inside a box are used to pin-point the item-of-interest, in this case Lane Motor 1R's location inside of the Cursor Window's Working Area Frame. The box shows that the Lane Motor 1R is in Unit 1, while the circle shows that the lane Motor 1R is in the middle right area of Unit 1. This pinpointing of physical location allows a technician to quickly locate the physical part (represented by the item-of-interest) on the complex machine.

### Cursor Window Example 3

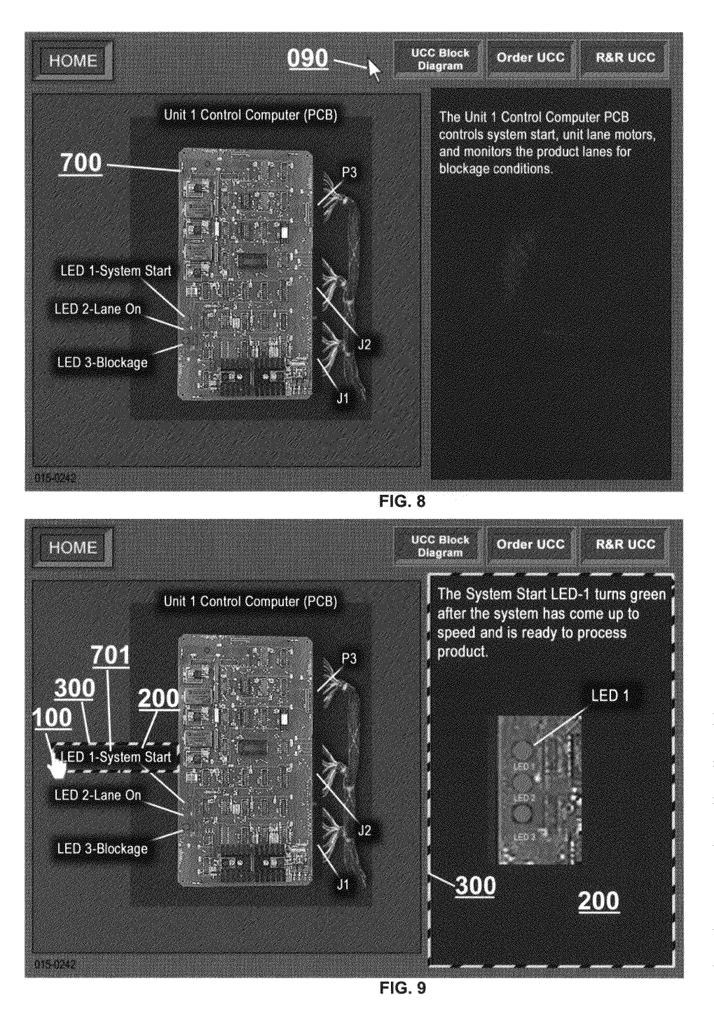

FIG. 8 depicts the Unit 1 Control Computer (UCC) PCB (700), with a non-mouse-over cursor (090) and no active Cursor Windows (no Working Area Frames). When the cursor is placed over a hot-spot on the PCB, however, the GUI changes to reflect the desire for additional information as depicted in FIG. 9. In this figure, the cursor (100) has been positioned over the LED-1 System Start text label hot-spot (701). In response, the Cursor Windows (200) are framed with yellow and black dashed Working Area Frames (300). The Working Area Frames (300) highlight additional information related to the 701 LED-1 System Start text label.

### Cursor Window Example 4

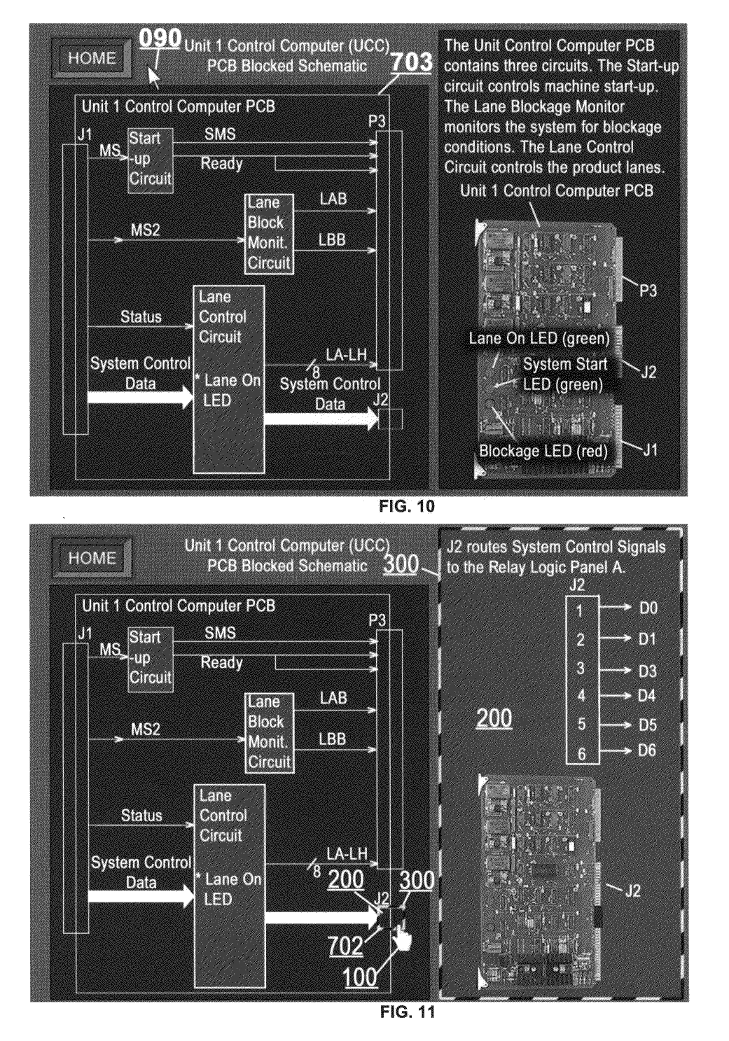

In another example, FIG. 10 depicts the Unit 1 Control Computer PCB's Block Diagram Schematic (703) with no active Cursor Windows and a non-mouse-over cursor (090). When the cursor is placed over a hot-spot on the block diagram, however, the GUI changes to reflect the desire for additional information as depicted in FIG. 11. In this figure the cursor (100) has been positioned over jack J2's hot-spot (702). Again, in response, the Cursor Windows (200) are framed with yellow and black dashed Working Area Frames (300). The Working Area Frames (300) highlight additional information related to the jack, J2 (702).

### Information Packing

In the present embodiment the Information Packing design anticipates what the user is looking for and packs the surrounding area with related assistive information. Information Packing is a design concept that uses the cursor, hot-spots, and Cursor Windows to pack information around items-of-interest. Items-of-interest are chosen in advance by the designer of the embodiment, who then creates corresponding hot-spots and additional detailed information to be displayed in the associated Cursor Windows. Hot-spots typically consist of hyperlinks to the additional data. The hot-spots can be created by use of embedded links, inline links, and/or image maps.

The information in the Cursor Windows is not displayed until the cursor is positioned over the item-of-interest's hot-spot. When the Cursor is over an item-of-interest's hot-spot, the detailed information about the item-of-interest is displayed in Cursor Windows that are framed with the Working Area Frame. The information displayed can be any form of multi-media, such as pictures, text, audio, video, line art, etc. To view additional information about the item-of-interest the user need only click (or select) the hot-spot.

FIG. 6 and FIG. 7 also reflect the Information Packing concept. In FIG. 6 a typical Detailed Block Diagram's window is displayed with no active Cursor Windows and a non-mouse-over cursor (090). However, in FIG. 7 the cursor (100) has been moved over the item-of-interest Lane Motor 1R's hot-spot (705). In response, information related to Lane Motor 1R is displayed in Cursor Windows (200) and a circle inside a box appears on the top image (201). The box represents that the Lane Motor 1R is in Unit 1 while the circle represents that the lane Motor 1R is in the middle right area of Unit 1. The Cursor Window (706) displays additional detailed information about the Lane Motor 1R. With the information in the Cursor Windows (200), the user can make an informed decision as to whether or not this is the appropriate navigational path to choose. The information packing technique is very powerful, allowing the designer to pack enormous amounts of information into one window. This information allows the user to intelligently navigate through The GUI.

### User Interaction

The GUI relies on visual information to stimulate intuitive interactions with operators and technical users. Operators and technical users are typically intimately familiar with what the machine does and how it functions. For example, consider a machine that prints checks and address information on envelopes. The machine inserts the checks into envelopes and sorts the envelopes according to the address into plastic bins. To the user it may not be obvious exactly how the inner workings of the machine function, but that same user has a clear understanding of what the machine accomplishes.

In the past, an inside-out approach to training/maintenance documentation has been used. This inside-out approach required leader-led training, computer based training, self-study, and years on the job to attain an expert level of knowledge of a complex machine. The inside-out approach concentrates on how the machine achieves its results.

The GUI of the present invention uses an outside-in approach that employs location and appearance, fault, symptoms, and what the machine does (functions) to guide the user to very detailed maintenance information without any prior machine specific technical training or maintenance documentation. Learning how to use The GUI to locate detailed information turns a novice machine operator into a machine expert almost instantly and learning how to use the GUI is quick and easy.

### Three Layered Diagrams OBD-IBD-DBD

The present embodiment provides three diagram levels; overall, intermediate, and detailed. The levels enable the user to move from a high level (coarse detail) through an intermediate functional level to a maintenance support or highly-detailed functional level. The Overall Block Diagram (OBD) is designed to get the user to the right circuit or function's Intermediate Block Diagram (IBD). To do this the OBD uses text, visual images of the machine, and a functional circuit layout that the user can relate to. The functional layout relates to what the machine does, allowing a user with no technical training or maintenance documentation on the machine, but knows what the machine does, to trouble shoot at an expert level. The IBDs and Detailed Block Diagrams (DBD) work together to make understanding and troubleshooting of complex circuits or functions relatively quick and easy.

The IBD is an intermediate level diagram that shows relationships between all the components (items-of-interest) in a circuit or function, the DBD shows technical details about the components (items-of-interest) in a circuit or function. The IBD is typically a one window Block Diagram but can require multiple windows. IBDs have electrical and/or mechanical signal connections to other circuits or functions IBDs. A DBD typically has multiple windows, but can be only one window. The DBD's contain the most technical information required to maintain/repair the machine.

The OBD usually requires only one window, but complex systems can require multiple windows. Unlike the IBDs and DBDs, the OBD shows all of the systems circuits or functions. The OBD provides links from each circuit or function to that circuit's or function's IBD. Each circuit or function has its own IBD and DBD.

IBDs have signal links to follow signals to and from other IBDs. The IBDs also have level links to move from the IBD item-of-interest to the item-of-interest's DBD. The DBDs have signal links to follow signals inside the circuit or function and links to follow signals to/from other circuits or function's DBDs. Multiple window DBDs have signaling links connecting to the other windows off a DBD. The DBDs also have level links to move from the DBD item-of-interest to the IBD item-of-interest. This capability is very useful when trouble shooting an item-of-interest in a large complex circuit.

Navigating into the Three-Layered Diagrams

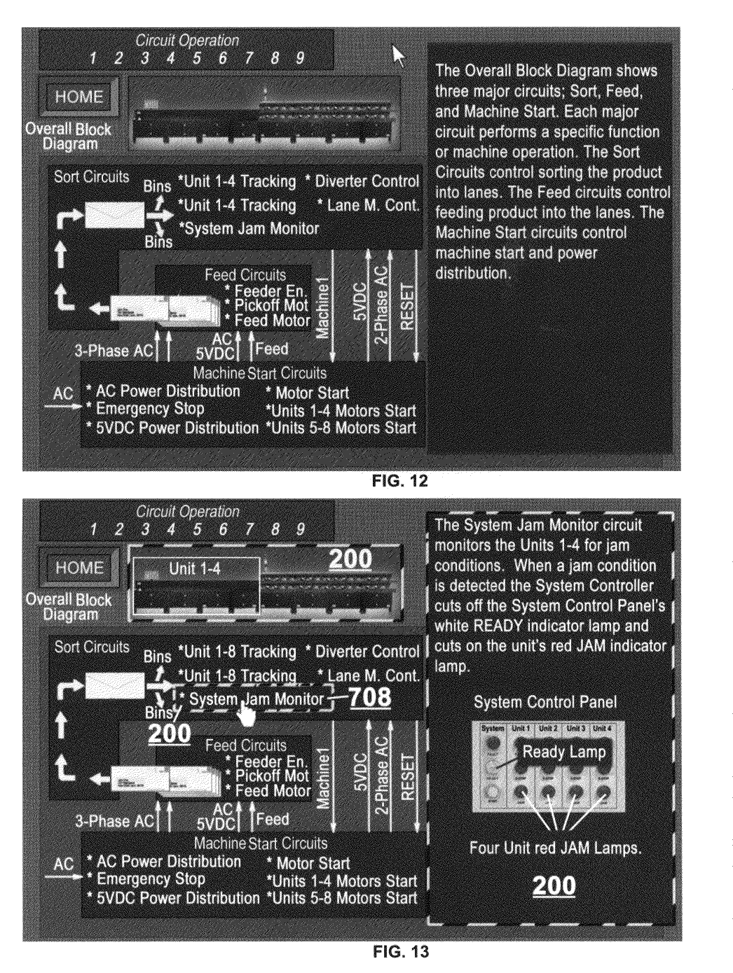

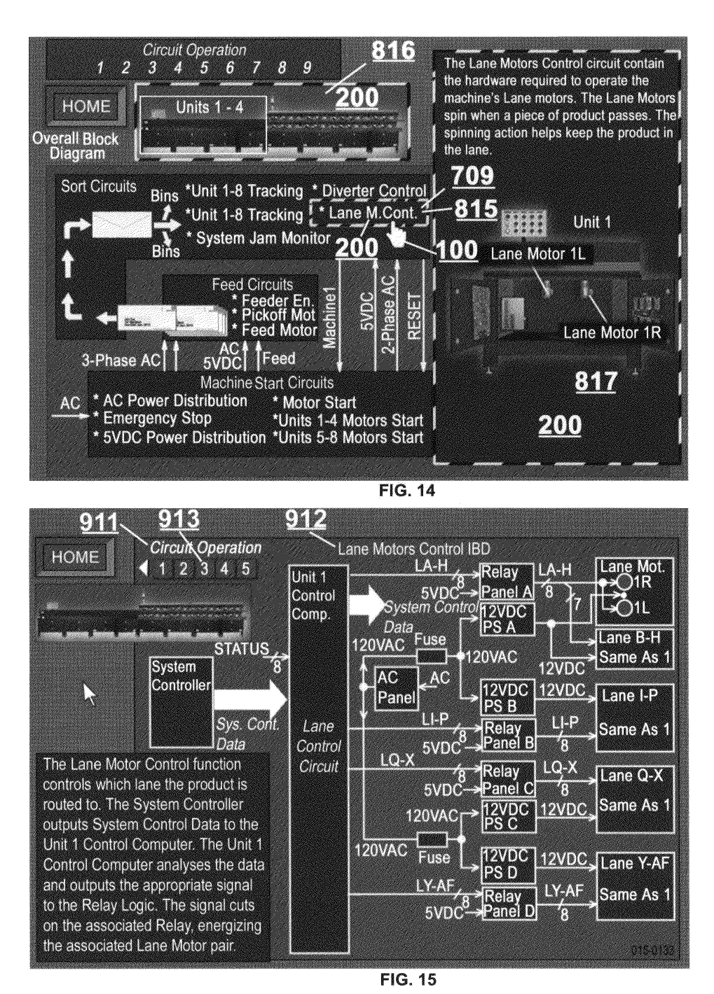

Referring again to FIG. 2, the home page window is displayed having no active Cursor Windows and a non-mouse-over cursor (090). In FIG. 5 the cursor (100) has been moved over the Overall Block Diagram button's hot-spot and the associated Cursor Window's display (200). If the user clicks on the hot-spot, he or she is presented with the OBD window as depicted in FIG. 12. The OBD provides links from items-of-interest (each circuit or function) to the corresponding circuit's or function's IBD. In FIG. 13 the cursor has been positioned over the System Jam Monitor text label's hot-spot (708) and related information is displayed in the corresponding Cursor Windows (200). In FIG. 14 the cursor (100) is positioned over the Lane Motors Control circuit's text label hot-spot (709) and related information is displayed in the Cursor Windows (200). By selecting the Lane Motors Control hot-spot (709), the focus is shifted to the Lane Motors Control Circuit IBD window.

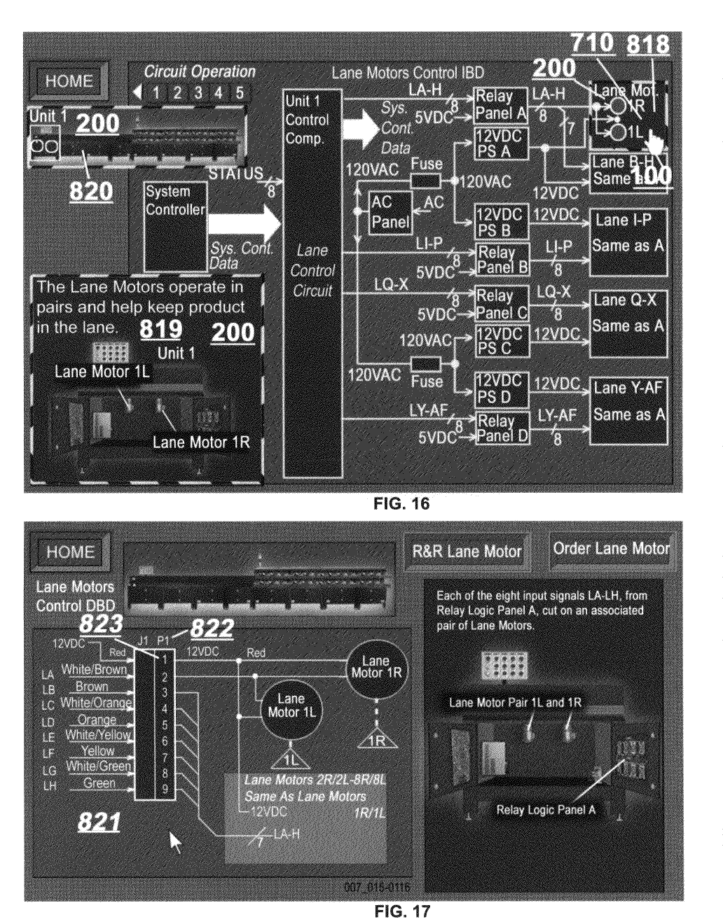

The Lane Motors Control Circuit IBD window is depicted in FIG. 15. In FIG. 16 a situation is depicted in which the user wants to learn more detailed information about Lane Motors 1R and 1L by positioning the cursor (100) over the Lane Motors 1R and 1L hot-spot (710). Consequently, additional detail is provided in the Cursor Windows (200). After examining the Cursor Windows the user determines that this is the path the user wants to follow, so the Lane Motors 1R and 1L's hot-spot (710) is selected to navigate to the additional detailed information. Upon selection, the Lane Motors Control DBD is displayed in FIG. 17. The Lane Motors Control DBD provides all the detailed information required to repair and maintain Lane Motors 1R and 1L. To navigate back to the IBD from the DBD, the cursor (100) may be positioned over the hot-spot (711) above Lane Motor 1R and clicked, as depicted again in FIG. 7. This returns the user to the Lane Motor Control IBD window as depicted in FIG. 15. This back and forth linking of the IDB and DBD is a very powerful trouble shooting aide.

Navigating from IBD to IBD

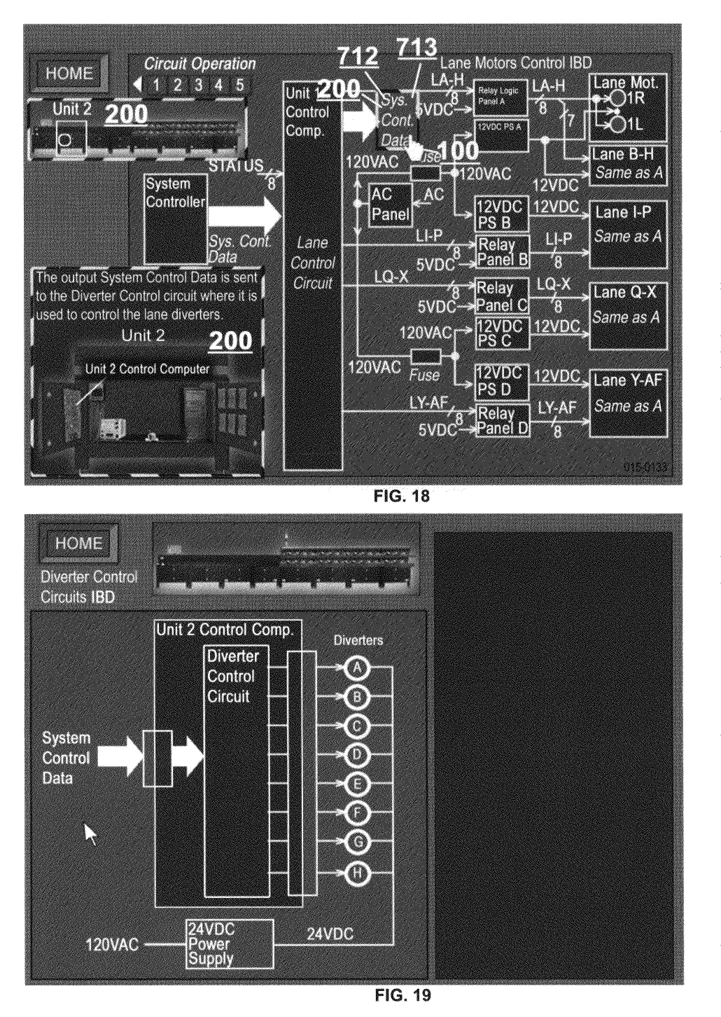

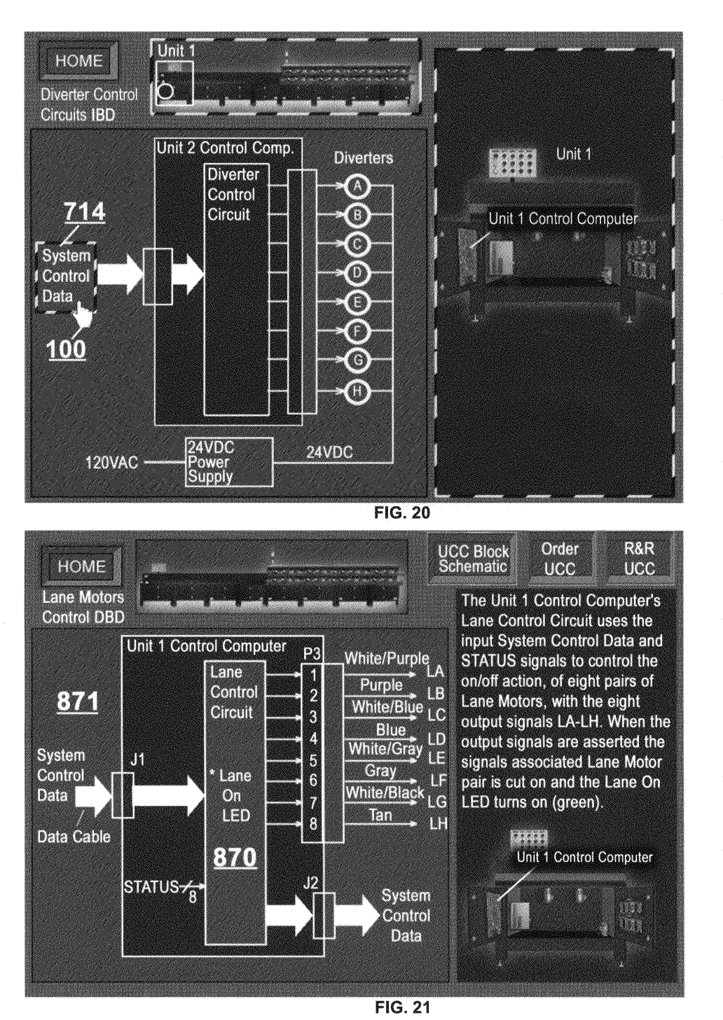

Signal links are provided for the user to follow the signals going to or from one IBD window to another IBD window. For example, in FIG. 18, the user can move the cursor (100) to the System Control Data (712) signal's hot-spot (713) and observe the Cursor Windows (200) to follow the System Control Data signal from the Lane Motors Control IBD window to the Diverter Control IBD window. The user may then follow the signal to the Diverter Control IBD shown in FIG. 19 by clicking on the appropriate hot-spot (713). In FIG. 20, to return to the Lane Motor Control IBD, the cursor (100) has been moved to the System Control Data signal's hot-spot (714). Clicking on the hot-spot returns the user to the Lane Motor Control IBD window shown in FIG. 15.

Navigating from DBD to DBD

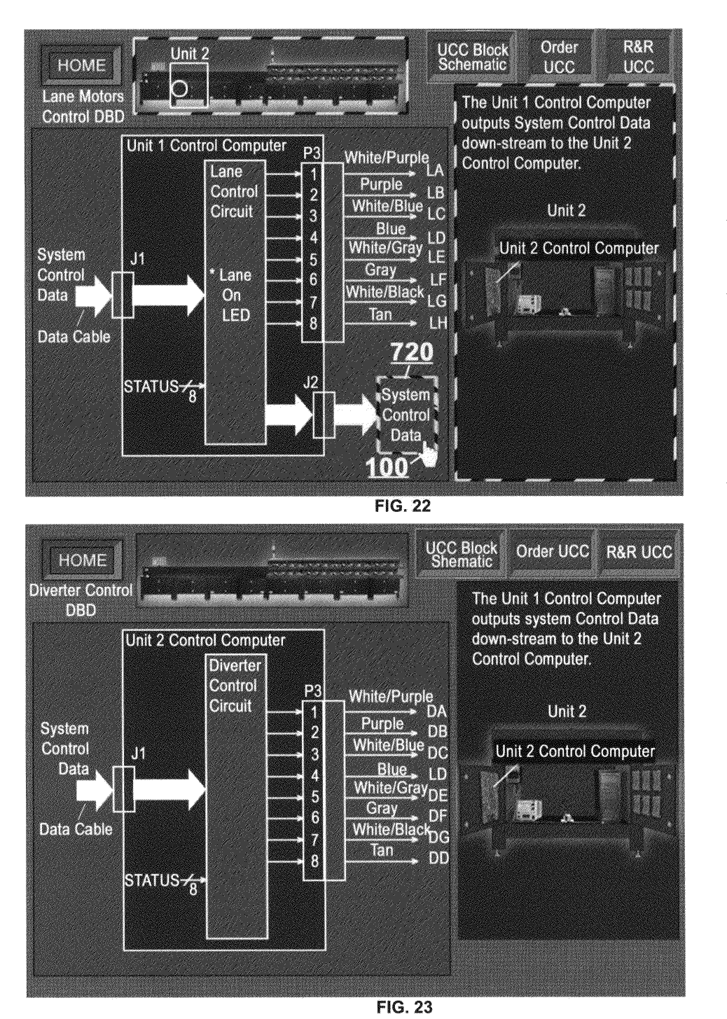

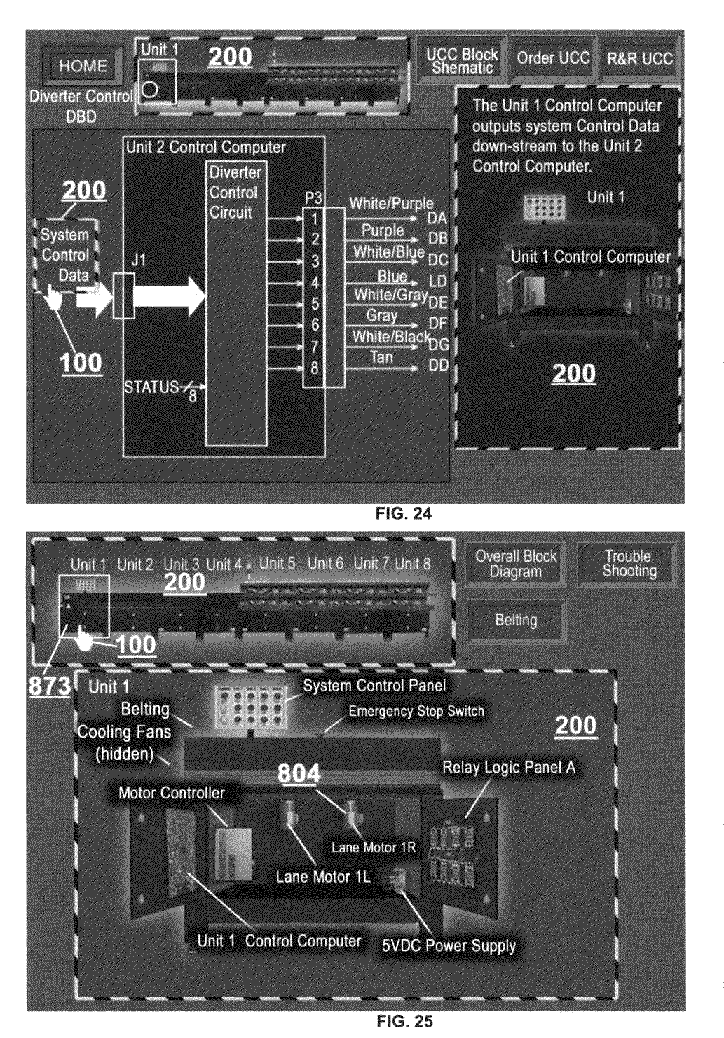

An additional Lane Motor Control DBD window is displayed in FIG. 21. By positioning the cursor (100) over the System Control Data output signal's hot-spot (720) and clicking it as shown in FIG. 22, the Diverter Control DBD's window is displayed, causing the GUI to appear as in FIG. 23. In FIG. 24 the user has moved the cursor (100) to the System Control Data input signal's hot-spot. Selecting this hot-spot returns the user to the Lane Motors Control DBD's window as depicted once again in FIG. 21.

Multiple Entrances into the GUI

The intuitive interactions between the user and The GUI are stimulated by visual reactions to images displayed on the active-window. The visual information can be pictures, line art, text, animation, video, audio, or any combination of such multimedia. The intuitive interaction begins after logging in with the user looking at the home page window as shown again in FIG. 2. The GUI has multiple entrances (021, 022, 023, and 024) as shown again in FIG. 1. The user can locate the detailed maintenance information about any item-of-interest in question by navigating into The GUI by:
The item-of-interests Physical Appearance and Location entrance (021).
   The user knows where the item-of-interest is located and what it looks like (its physical appearance). The user navigates to the item-of-interest by using pictures of the machine.
What function an electrical item-of-interest does in an electrical circuit (Overall Block Diagram) entrance (022).
   The user knows what the machine is not doing, i.e. not running product because of repeated jams in Unit 1 because a Lane Motor isn't working. The user can locate detailed information about the faulty Lane Motor by going to the Overall Block Diagram and selecting the Lane Motors Control circuit.
What function a mechanical item-of-interest does (Belting) (023) entrance.
   The user knows what the machine is not doing, i.e. not running product because of repeated jams in Unit 1. After visual examination, it is determined that a belt is broken, causing the product to jam. The user can locate detailed information about the missing belt by navigating down through the Overall Belting Diagram.
Trouble Shooting (024) uses symptoms to guide the user to the faulty item-of-interest.
   The user knows what the machine is not doing, i.e. not running product because of repeated jams at the same spot. The user can locate detailed information about the symptom by going to Trouble Shooting and selecting the symptom from a list of symptoms. The user then follows a trouble shooting procedure to resolve the fault.

### Physical Appearance and Location: Fault Symptom Scenario

The user can locate detailed technical information about any item-of-interest on the machine by simply knowing its location and its appearance. For example, consider the following fault Symptom Scenario. As product is moving through the machines transport system it is repeatedly jamming at the same spot. The user has noticed that the machine is jamming repeatedly at the same spot. After a visual inspection the user discovers that a motor isn't turning and that product is repeatedly jamming at that motor. The user is tasked with Removing & Replacing (R&R) the faulty motor.

At this point, the user doesn't know the name of the motor or the name of the unit (location) the motor is in. The user can see where the motor is located (location) and what it looks like (its appearance). The user then logs into the GUI of the present invention. The GUI displays the home page as shown in FIG. 2. On the home page several items are displayed, including a picture of the machine, with invisible hot-spots located over each unit of the machine.

The user positions the cursor (100) over the location on the machine in which the motor resides in the top image as in FIG. 25, which is in this case Unit 1. Consequently, the Cursor Windows (200) display more detailed information about Unit 1. The more detailed information displayed in the Cursor Windows help the user to decide if this is the right unit or not. The user can see that this is the unit in which the faulty motor (804) resides, and clicks on the Unit 1 hot-spot.

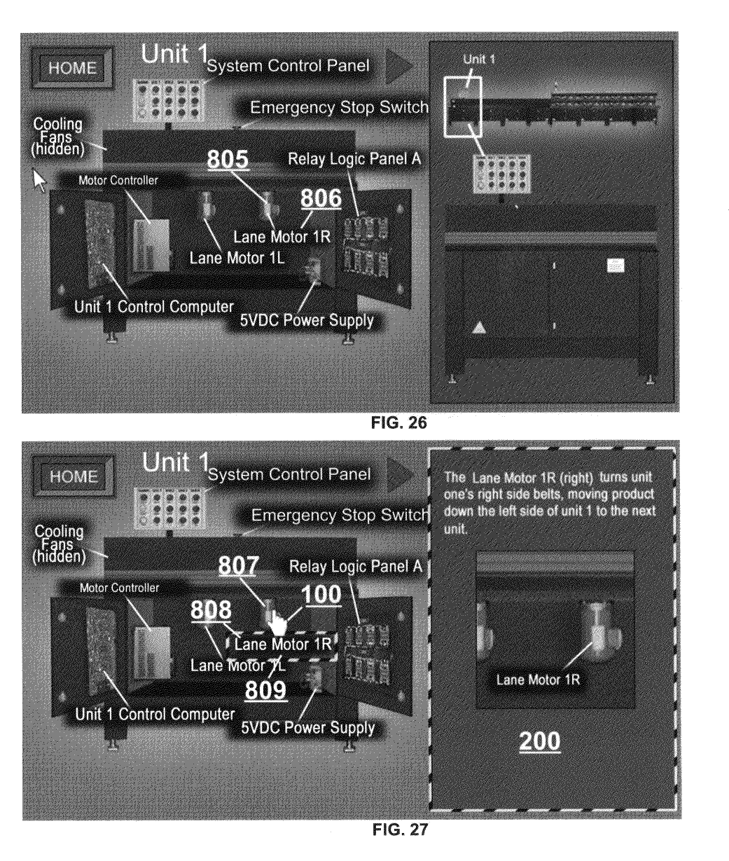

A detailed picture of Unit 1 is now displayed in FIG. 26. The picture points out Unit 1's items-of-interest, including the suspected faulty motor (805) and its name “Lane Motor 1R” (806). The user then positions the cursor (100) over the suspected faulty motor's hot-spot as in FIG. 27. The motors name, “Lane Motor 1R,” is then associated with Cursor Window (809) and additional detailed information about the motor is displayed in the larger Cursor Window (200). Both the item-of-interest (807) and the item-of-interest callout (808) have hot-spots associated with them. This allows the user to select one of these items-of-interest by moving the cursor over the item or its respective call out (name), eliminating the need for the user to know the item-of-interest's true name. Once the user decides that this is the faulty motor, the user clicks on the motors hot-spot to navigate to more detailed information about Lane Motor 1R.

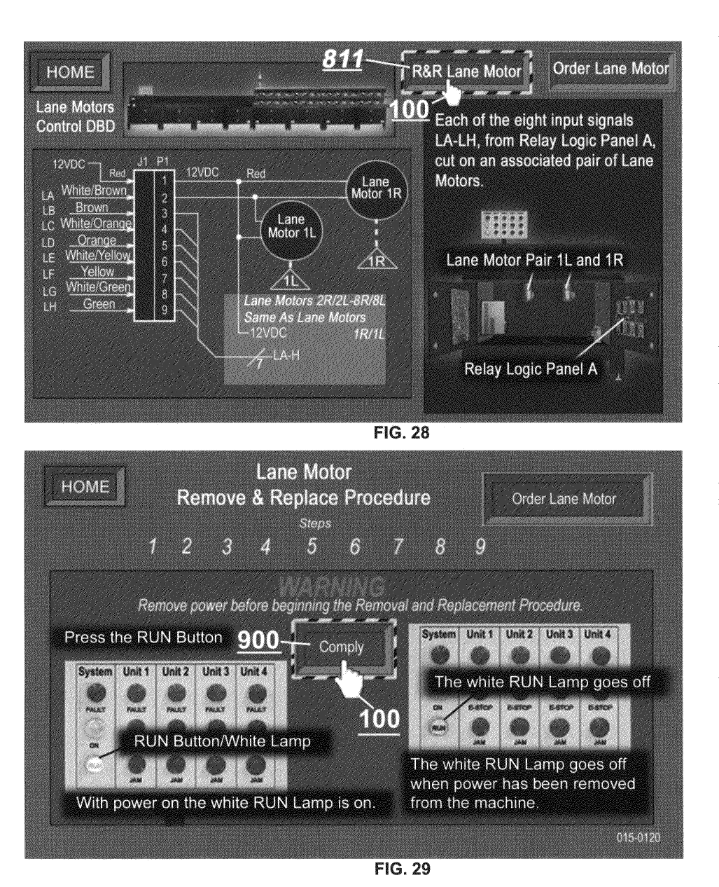

The Lane Motors Control DBD window is now displayed as shown in FIG. 6. This window contains a button labeled “R&R Lane Motor” (Remove & Replace) (810). The user then moves the cursor (100) to the “R&R Lane Motor” button hot-spot (811) as in FIG. 28 and clicks to display the R&R Lane Motor procedure window. The Lane Motor R&R procedure window is depicted in FIG. 29. The Lane Motor R&R procedure uses Stop & Go Video to communicate necessary information in steps. As depicted in this figure, the user positions the cursor (100) over the “Comply” button's hot-spot (900). When the user clicks on this button's hot-spot the steps functionality is activated. This click indicates to the Management Software (MS) that the user will comply with the safety warnings.

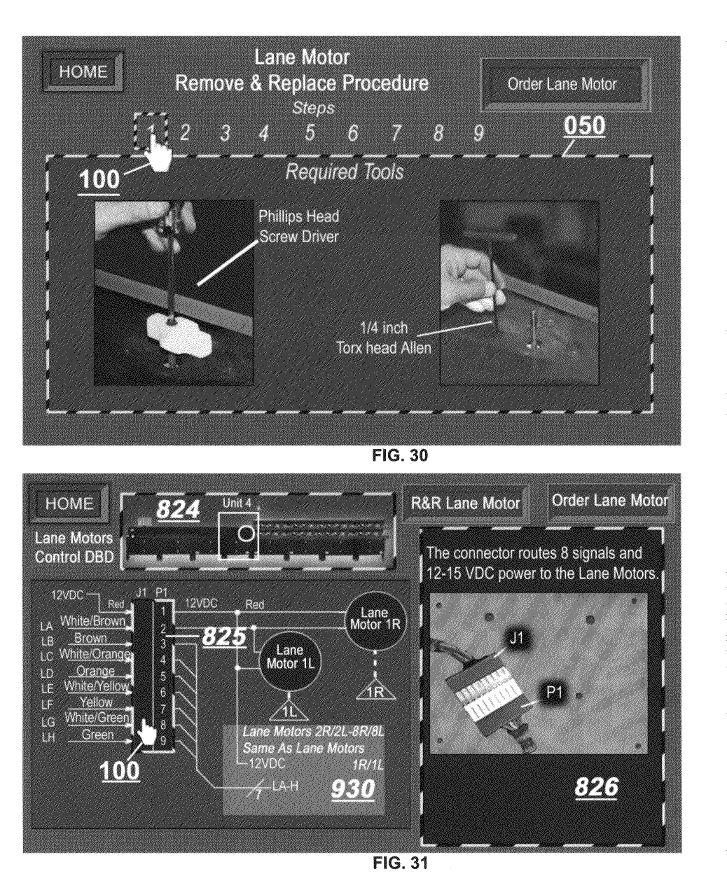

In FIG. 30 the user has moved the cursor 100 to step 1's hot-spot. The procedural information for step 1 is displayed in the Cursor Window's framed by the Working Area Frame (050). Continue to move the cursor over the steps 2-9 hot-spots and observe the procedural steps shown in the associated Cursor Windows.

### Electrical Circuit Functions: Intermittent Fault Scenario

Consider the following intermittent fault scenario. There have been an unacceptable number of intermittent product jams at Unit 1's 1R and 1L Lane Motors. A jam causes the machine to stop. After the jam has been cleared, the machine restarts and runs, but soon jams again at 1R and 1L Lane Motors. Intermittent faults are typically the hardest faults to identify and isolate. The user decides to use the circuit functional diagrams to identify the component causing the intermittent product jams.

The user suspects the circuit that powers Unit 1's Lane Motors is opening up due to vibrations, heat, and/or product pressure. The Lane Motors stop when the circuit opens, resulting in product jamming in the 1R and 1L Lane Motor area. The user isn't sure what is causing the jams, even after a visual inspection during operations. At this point, the user wants to learn about the circuit that controls the Lane Motors so the user can look for possible causes of the product jams.

The GUI's homepage display is shown in FIG. 2. Next the user selects the Overall Block Diagram (OBD) 813 button as shown in FIG. 5, causing the OBD window to display as in FIG. 12. The user then moves the cursor across the OBD window to the text “Lane Motors Control's” hot-spot (815) as in FIG. 14. With the cursor over “Lane Motors Control's” hot-spot (815) the Cursor Windows displays detailed information about the Lane Motors Control circuit. The Cursor Window (816) displays a picture of the machine with a white box (Moving Shape) around units 1-4 in the top image, identifying that the Lane Motors are located in units 1-4 of the machine. The Cursor Window (817) then displays descriptive text about the Lane Motors Control circuit and provides a more detailed picture of Unit 1 that has callouts pointing to Lane Motors 1R and 1L. The Lane Motors are mounted the same way in all units. Based on the information displayed in the Cursor Windows, the user can determine if this is the circuit that could be causing the jamming symptoms. After studying the information in the Cursor Windows, the user decides that this is the circuit that controls the on/off action of the Lane Motors. The user then clicks on the Lane Motors Control's hot-spot to navigate to more detailed information about the Lane Motors Control circuit. After clicking on the hot-spot, the Lane Motors Control Intermediate Block Diagram (IBD) displays as in FIG. 15.

The Lane Motors Control Circuit's IBD displays the item-of-interests that are used to control the operation of the machines Lane Motors. In FIG. 16 the user has moved the cursor (100) to Lane Motors 1R and 1L's hot-spot (818) and observes the Cursor Windows (819) and (820). The Cursor Windows display enough information to confirm that 1R and 1L are the Lane Motors in question. The user clicks on the Lane Motors 1R and 1L's hot-spot (818).

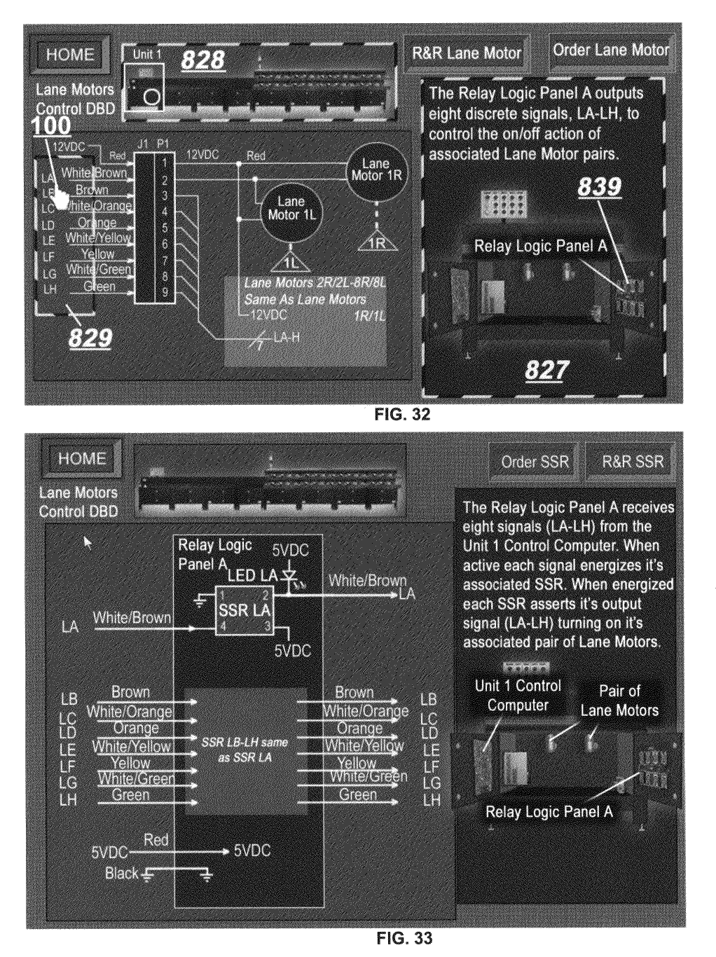

The Lane Motors Control's Detailed Block Diagram (DBD) then displays in FIG. 17. The Lane Motors Control DBD provides an electrical schematic (821) of the Lane Motors and their associated wiring. From the schematic, the user traces the Lane Motor wires back to connectors J1/P1 (822). The user can see that the wires terminate at connector J1/P1's pins 1 and 2 (823). This wiring configuration indicates that both Lane Motors 1R and 1L turn on and off simultaneously. In FIG. 31 the user has moved the cursor 100 over the J1/P1 connector and observes the Cursor Windows (824, 825, and 826). The Cursor Windows display detailed information about the location and appearance of the connectors J1/P1. From the schematic, the user can see that pin 1 routes 12 VDC to Lane Motors 1R-1L and 8R-8L (930). Since the only Lane Motors that are not working are 1R and 1L, the 12 VDC power supply can be eliminated as the cause of Lane Motors 1R and 1L fault. In FIG. 32 the user follows the signal LA on J1/P1 pin 2. The user moves the cursor (100) to signal LA's hot-spot and observes the Cursor Windows (827, 828, and 829). The Cursor Windows display detailed information about where the signal LA is coming from, which in this case is Unit 1's Relay Logic Panel A (839). The Relay Logic Panel A is mounted on the back of the right side access door of Unit 1 (828). The user clicks on LA's hot-spot to follow the signal. The Lane Motors Control DBD's Relay Logic Panel A schematic then displays as in FIG. 33.

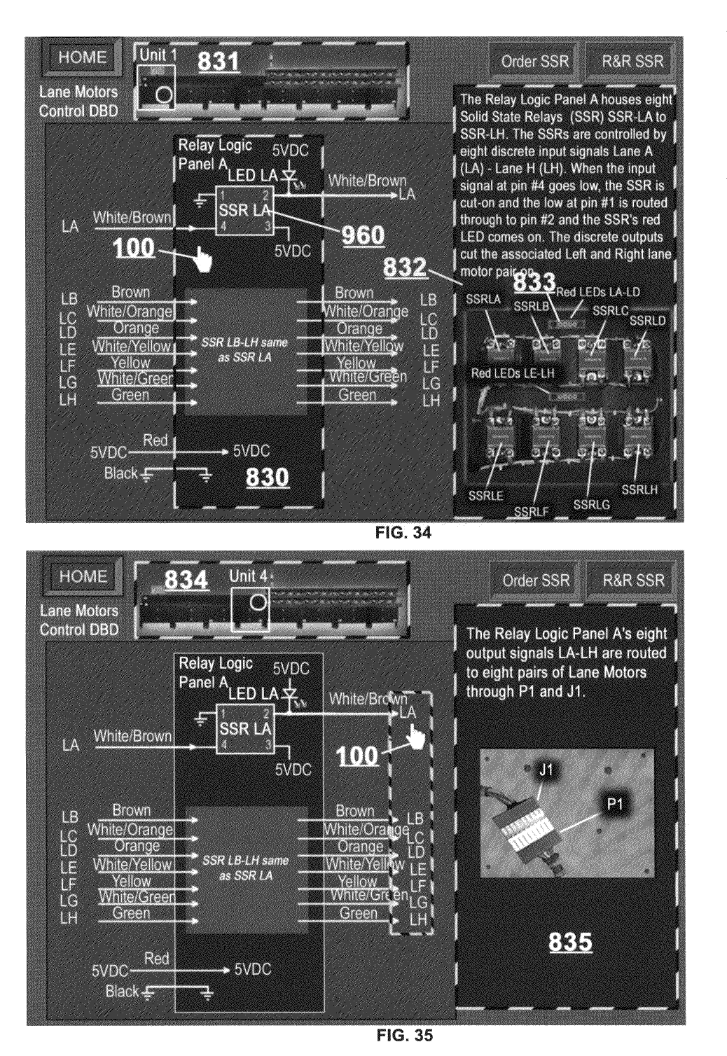

In FIG. 34 the user moves the cursor (100) over the Relay Logic Panel A's hot-spot. The Cursor Windows (830, 831, and 832) then display detailed information about Relay Logic Panel A. The first Cursor Window (831) displays location information and the second Cursor Window (832) displays descriptive text and a picture of Relay Logic Panel A. With this information, the user can identify the item-of-interest that outputs the signal LA to the Lane Motors 1R and 1L. In this example, the SSR LA (960) outputs signal LA. The information in the Cursor Window (832) indicates that the red LED LA (833) comes on when the output signal from SSRLA pin 2 LA goes low. When the signal LA goes low, Lane Motors 1R and 1L should turn on.

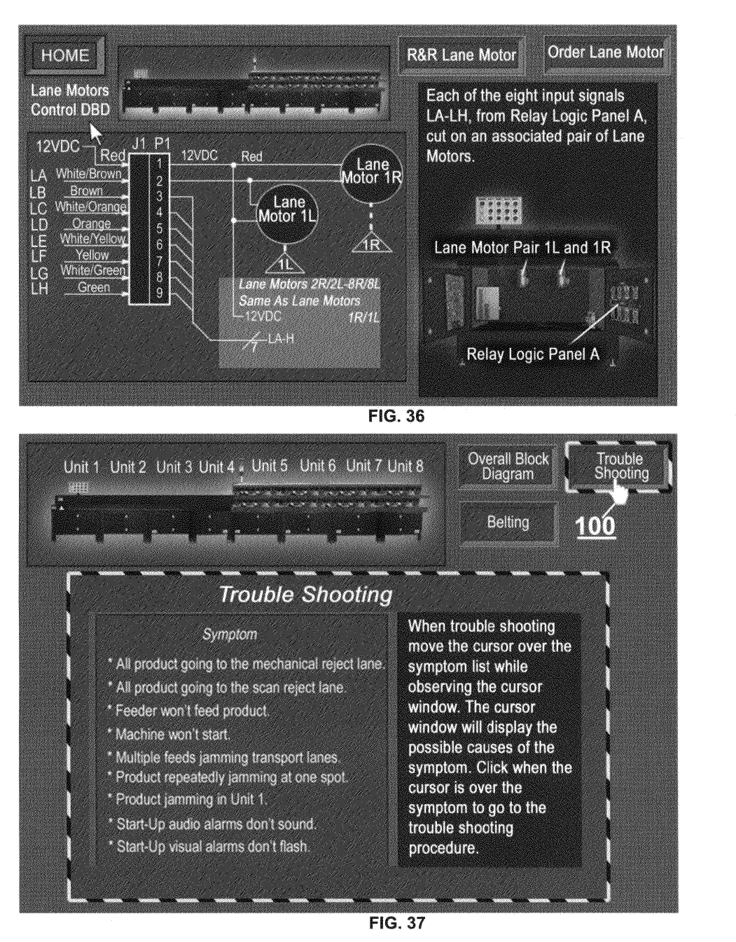

The user now knows that there is a maintenance aid LED LA that can be used to isolate the intermittent fault in the Lane Motors Control circuit. The user restarts the machine and observes LED LA. The machine starts but quickly jams. The user observes that LED LA remains on even though the Lane Motors aren't running. This indicates that the signal LA is good at the output of SSRLA pin #2, indicating that the fault is downstream from SSR LA. In FIG. 35 the user follows the signal LA by moving the cursor (100) to the signal LA's hot-spot and observing the Cursor Windows (834 and 835). The Cursor Windows display information regarding the destination for signal LA. The Cursor Window (834) shows that connectors P1/J1 are located on the upper part of Unit 4. Another Cursor Window (835) displays descriptive text and a picture of the PIM connectors. The user clicks on the signal LA's hot-spot to follow the signal LA. The Lane Motors Control DBD's J1/P1 schematic displays in FIG. 36.

In FIG. 31 the user has moved the cursor (100) over the P1/J1 Connector's hot-spot and observes the Cursor Windows. Using the information in the Cursor Windows (836, 837, and 838), the user locates where the P1/J1 Connector is on the machine in the other Cursor Window (836) and sees what it looks like (appearance) (837). The user then locates the connectors on the machine and visually examines them. Upon visual examination, the user sees that P1/J1 have vibrated apart and are barely connected. The user identifies this as the source of the intermittent jams and firmly pushes the connectors together. The intermittent jams stop happening, the problem has been repaired.

### Trouble Shooting

The machine operator has been operating the machine long enough to become very familiar with what the machine does or its functions. While running the machine if there is a problem the operator is experienced enough to recognize what the machine isn't doing or in other words, the problems symptom. The operator can use the Trouble Shooting entrance to the GUI to locate the information required to repair the machine by looking up the symptom.

### Fault Symptom Scenario:

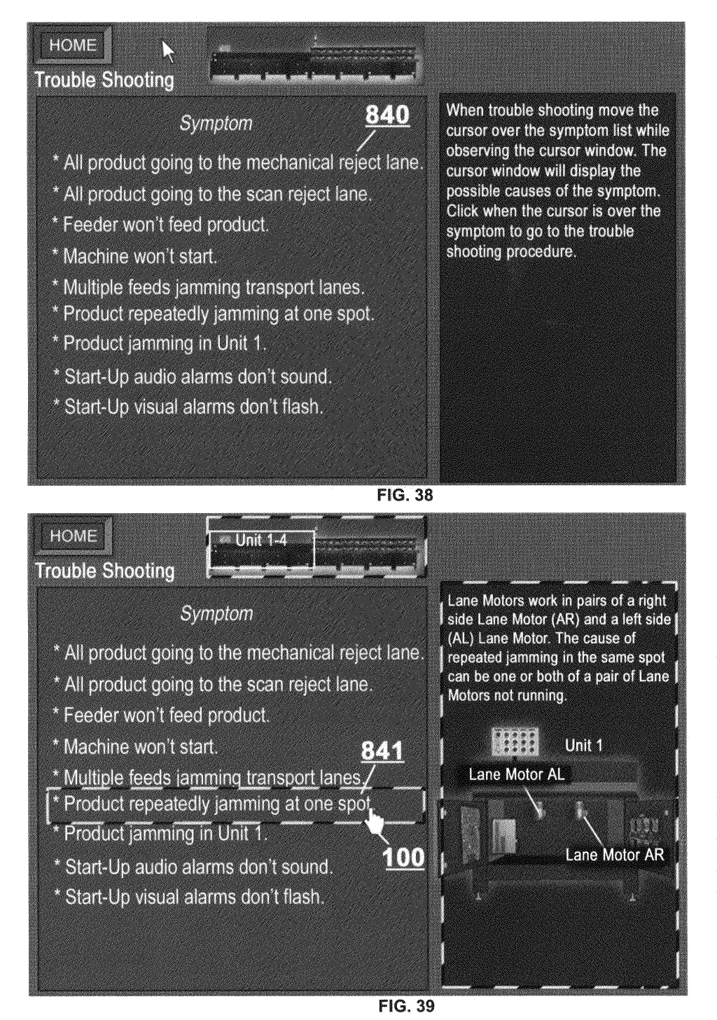

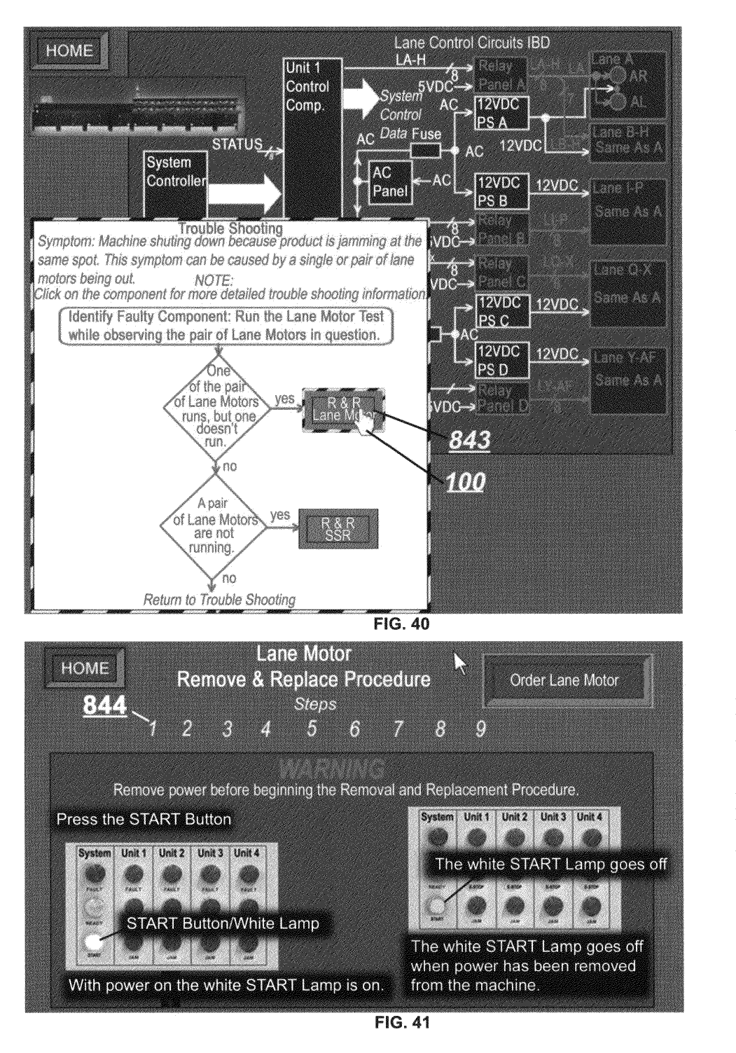

Consider the following fault symptom scenario: the machine's transport system is repeatedly jamming at the same spot. From the home page window of FIG. 2 the user moves the cursor (100) to the Trouble Shooting button's hot-spot as shown in FIG. 37 and clicks this hot-spot. The Trouble Shooting window displays as depicted in FIG. 38. From the list of symptoms (840), find the symptom that most closely identifies the problem. In this case, the symptom is “Product repeatedly jamming at one spot.” In FIG. 39 the user has moved the cursor (100) over the symptom “Product repeatedly jamming at one spot” hot-spot (841). The user clicks on this hot-spot and the symptom's troubleshooting procedure window displays (842) in FIG. 40. In this figure the user follows the Trouble Shooting procedure, moving the cursor (100) to the “R&R Lane Motor” button (843). The user clicks on the button to navigate to the Lane Motor R&R procedure. The Lane Motor R&R procedure window displays in FIG. 41. The user follows the Stop & Go Video procedure (844) steps 1-9 and removes the faulty Lane Motor then replaces it with a know good one, correcting the problem.

### Fault Symptom Scenario: Jams at Driven Belt 1 LA in Unit 1.

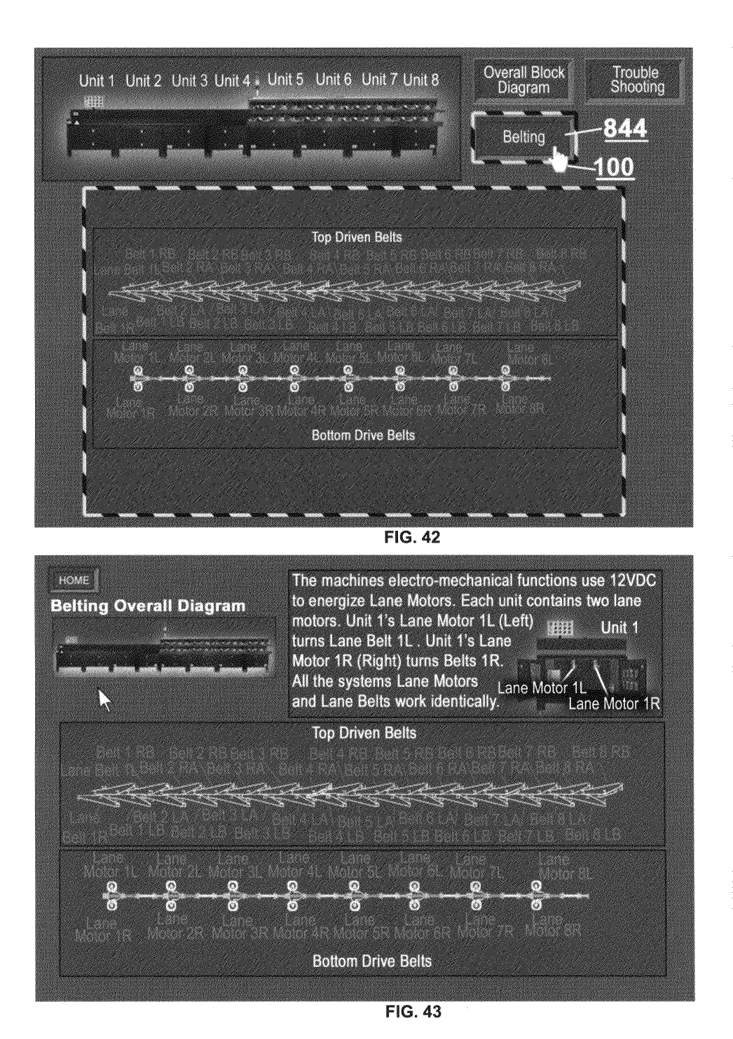

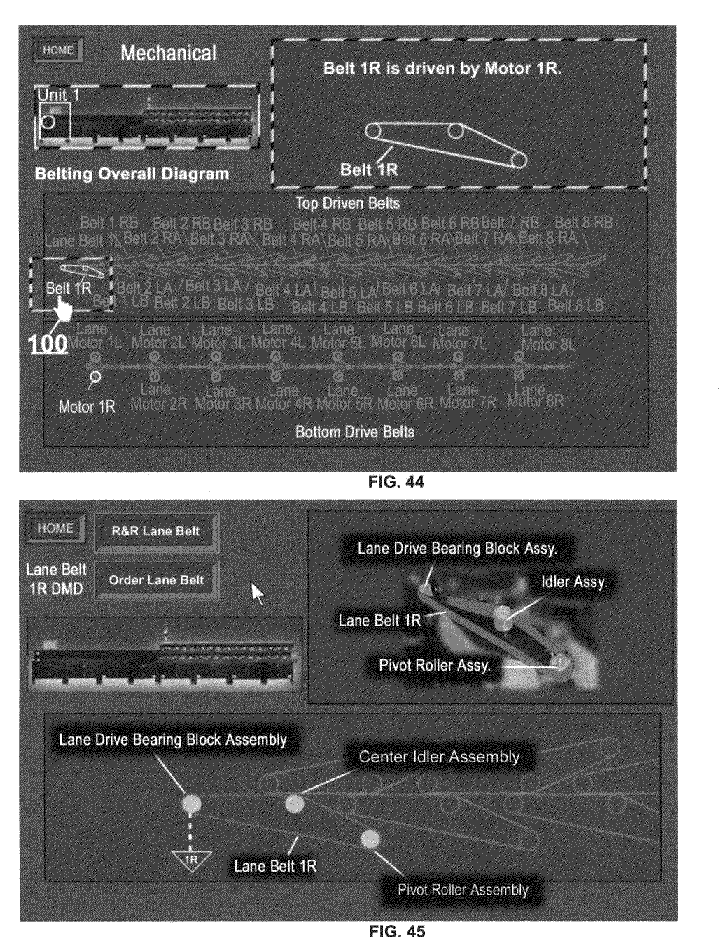

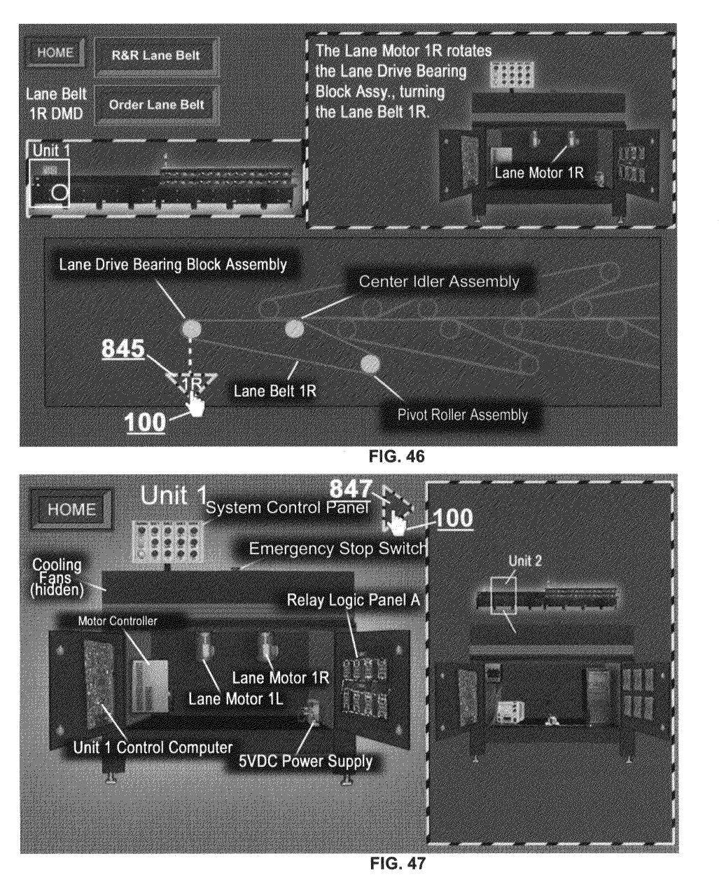

Consider a situation in which the user notices that product is jamming at Belt 1A. Upon visual inspection of the belt, the user notices that Belt 1 LA isn't turning. The user logs into The GUI, the homepage window displays as in FIG. 2. On the homepage window several items are displayed, including a Belting button. The user moves the cursor (100) over the Belting button's hot-spot (844) and clicks as in FIG. 42. The Belting Overall Diagram (BUD) window then displays as depicted in FIG. 43. In FIG. 44 the user has moved the cursor (100) over the BOD to Belt 1R's hot-spot. The user clicks on the hot-spot and the Lane Belt 1R Detailed Mechanical Diagram (DMD) displays as in FIG. 45. In FIG. 46 the user moves the cursor (100) to the electro-mechanical connection link 1R's hot-spot (845) and clicks. The Lane Motors Control DBD displays as in FIG. 6. Notice the corresponding electro-mechanical connection link 1R 846. Clicking on the link returns the user to the Lane Belt 1R DMD as in FIG. 45.

Moving from Unit to Unit

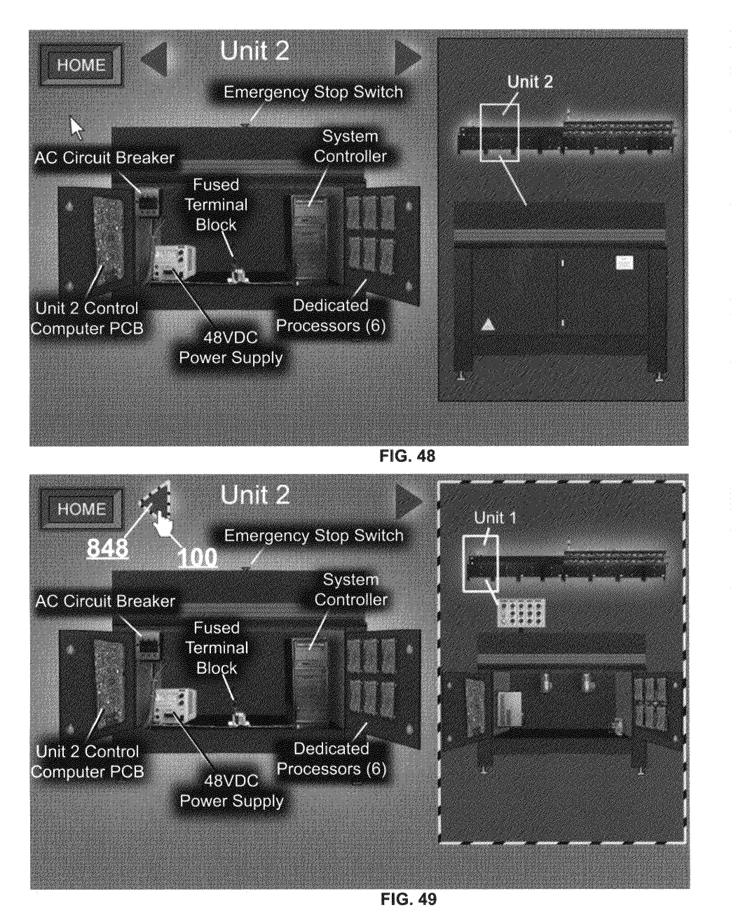

To improve usability, links that allow the user to navigate from Unit to Unit provides quick and easy access between units of the mechanical system. Consider the following scenario. The home page Window displays as in FIG. 2. The user moves the cursor (100) to Unit 1's hot-spot and observes the Cursor Windows as in FIG. 3. The user clicks on the hot-spot to navigate to the Unit 1 Window, which is displayed as in FIG. 26. Next, the user has moved the cursor 100 to the Next Unit Right Arrow's hot-spot (847) and observes the Cursor Windows as in FIG. 47. The user clicks on the Next Unit Right Arrow's hot-spot (847) to navigate to the Unit 2 Window as shown in FIG. 48. Next the user has moved the cursor (100) to the Next Unit Left Arrow's (848) hot-spot and observed the Cursor Window as in FIG. 49. The user clicks on the Next Unit Arrow's hot-spot to navigate back to the Unit 1 Window shown in FIG. 26.

### Stop & Go Video (R&R)

The Stop & Go Video (SGV) feature of the present invention is an effective and efficient way to review and learn about many types of complex subjects. For example, consider a parts Removal and Replacement (R&R) procedure. SGV mimics the time-sequence of video frames but provides much more control of the frame size, rate, and direction. Some of the benefits of SGV are the ability to access any frame (step) in the video at anytime, watch the frame (step) for as long as needed, move forward and backward as needed, etc. Most steps presented in SGV have mouse-over action but do not have a link because there is no more information required for that item-of-interest.

The Lane Motor R&R Procedure window is displayed as in FIG. 29. Next, the user moves the cursor (100) to step 1's hot-spot as in FIG. 30. The procedural information for step 1 is displayed in the resulting Cursor Window (849). Notice no clicking is required to display step information. The Cursor Windows are controlled by the position of the cursor.

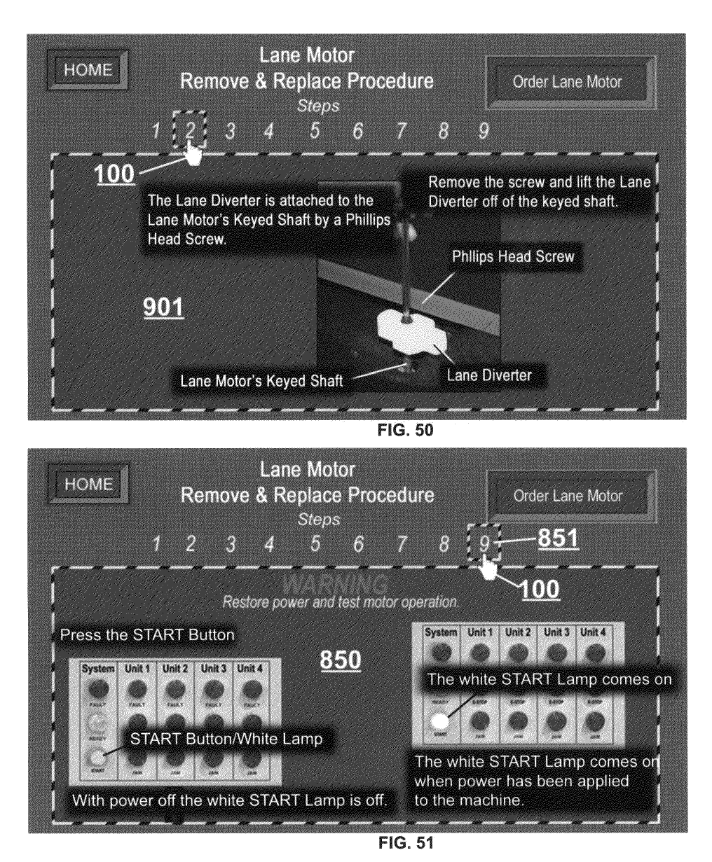

The user may then move the cursor (100) to step 2's hot-spot as depicted in FIG. 50. The procedural information for step 2 is then displayed in Cursor Window (901). The user continues to follow the sequence of steps until the user reaches step 9 as depicted in FIG. 51. The procedural information for step 9 is then displayed in Cursor Window (850).

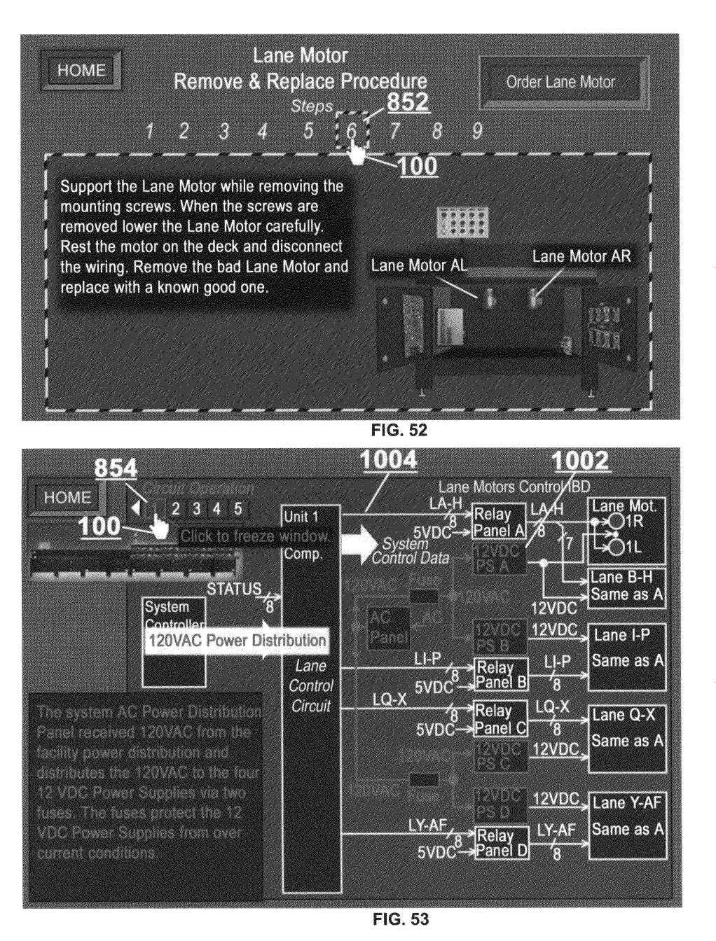

If the user wishes to review any step, he or she need only select the desired hot-spot. For example, if the user wants to review step 6 the cursor may be moved directly to step 6's hot-spot (852) as depicted in FIG. 52. This ability to access the steps in any order and to view the step as long as wanted is one of the powerful features of SGV.

### Stop & Go Animation (Circuit Operation) (See Figures in Color Exhibit B)

Stop & Go Animation (SGA) is a learning aid that uses colors to break up complex items. In this example a complex circuit is broken up into smaller less complex items or sub-circuits, while maintaining the relationship of the less complex items or sub-circuits to the larger complex item or circuit. In this embodiment SGA uses the colors (white, red, and yellow) to explain the operations of the complex circuit. The colors are used to break the complex circuit up into associated groups or sub-circuits of items-of-interest. SGA allows the user to study the complex circuit in a logical manner keeping track of the sub-circuits the user has covered, the current sub-circuit being displayed, and the sub-circuits yet not covered. In this embodiment the color white is used to represent sub-circuits not explained yet. The red color represents the current sub-circuits being described. The yellow color represents sub-circuits already explained. However, one skilled in the art will appreciate that any colors, shades of colors, or patterns of colors may be utilized and are within the scope of the invention.

A typical complex circuit is displayed in FIG. 15. This example SGA is titled Circuit Operation (911). This SGA explains the operation of a complex circuit referred to as the Lane Motors Control Circuit IBD (Intermediate Block Diagram) (912). SGA breaks the complex circuit's IBD into sub-circuits or sub-functions that work together to perform the machine function referred to as Lane Motors Control. Each sub-circuit has its own step. In this case there are five steps (913) required to cover the complex circuit's five sub-circuits.

When the user moves the cursor over a step's hot-spot certain colors and text change on the active-window. The color changes to focus the users attention on one sub-circuit while maintain the relationship that sub-circuit has with the other circuits that make up the overall complex circuit or function. The intended manner to use SGA is to start at step 1 and continue to the last step, in this case, step 5, but SGA allows the user to review the steps in any order.

In this embodiment, SGA has two distinct modes. The first mode or normal mode uses mouse-over events to display Circuit Operation information associated with that step. The normal mode has a Click to Freeze Window feature. When a Circuit Operation step's hot-spot is clicked on, the active-window for that step enters the frozen mode. The frozen mode freezes the current window in place, allowing the user to move the cursor around the frozen window observing mouse-overs and clicking on links as needed.

In FIG. 53 the user has moved the cursor (100) to Circuit Operation's step 1's hot-spot (854) and the pertinent information about step 1's sub-circuit is displayed in red (1002). In this example, the 120 VAC Power Distribution sub-circuit information is displayed as red (1002). The remainder of the complex circuit remains white (1004).

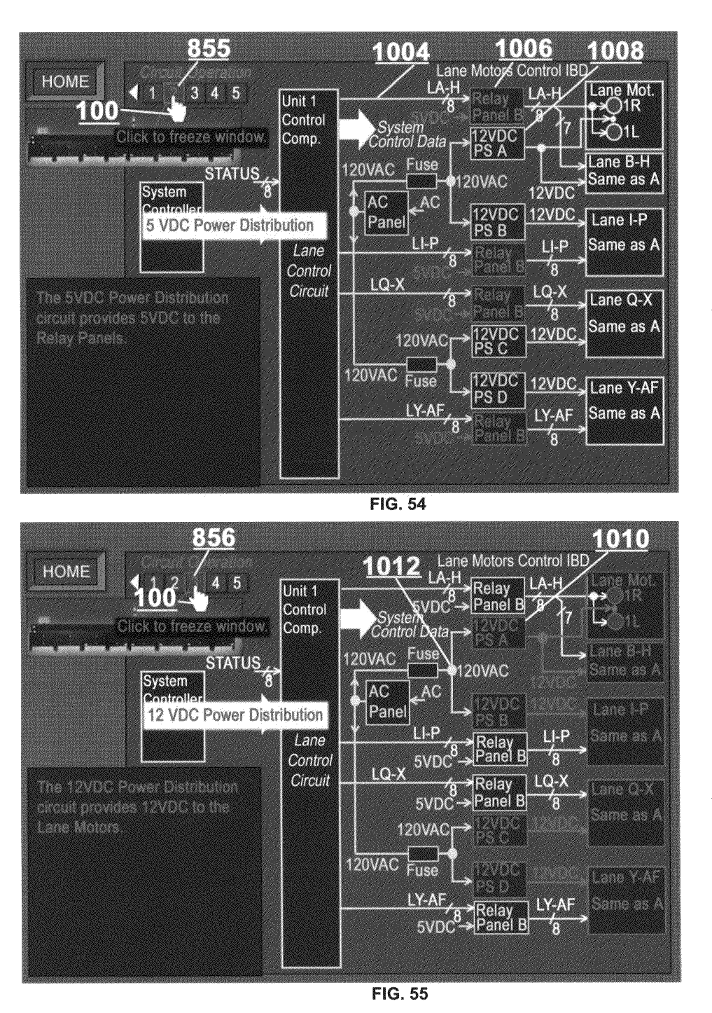

In FIG. 54 the user has moved the cursor (100) over step 2's hot-spot (855). The pertinent information about step 2's 5 VDC Power Distribution sub-circuit turns red (1006) and the information that was covered in step 1 turns yellow (1008).

In FIG. 55 the user has moved the cursor (100) over step 3's hot-spot (856) and the pertinent information about step 3's 12 VDC Power Distribution's sub-circuit turns red (1010) and the information that was covered in step land 2 turns yellow (1012).

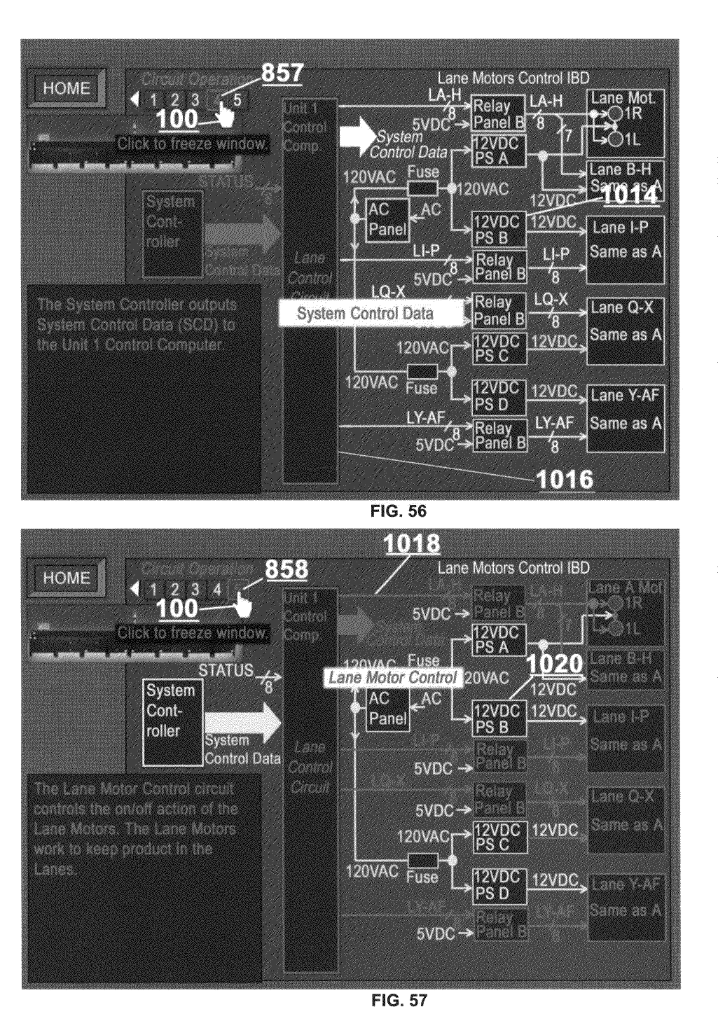

In FIG. 56 the user has moved the cursor (100) over step 4's hot-spot (857) and the pertinent information about step 4's System Control Data's sub-circuit turns red (1016) and the information that was covered in step 1, 2, and 3 turns yellow (1014).

In FIG. 57 the user has moved the cursors (100) over step 5's hot-spot (858) and the pertinent information about step 5's Lane Motor Control sub-circuit turns red (1018) and the information that was covered in step 1, 2, 3, and 4 turns yellow (1020). At this point, it is easy to see that the user has covered all of the information available for this complex circuit (no white circuits left).

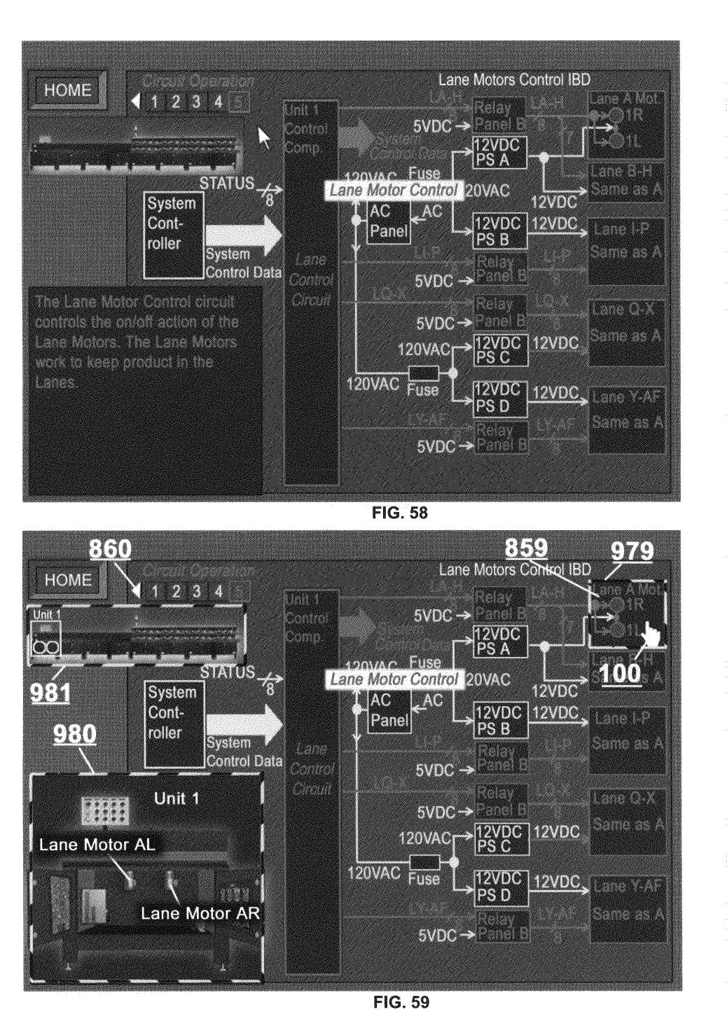

If the user is interested in learning more about the Lane Motor Control sub-circuit, the user may select step 5's hot-spot, freezing the window as shown in FIG. 58. In FIG. 59 the user has moved the cursor (100) over the frozen window to Lane A Motor 1R and 1L's hot-spot (859). In the frozen mode the Cursor Window's Working Area Frames are displayed (979, 980, and 981) and all links are active allowing the user to follow the item-of-interests throughout the GUI. To un-freeze the Lane Motors Control IBD window, move the cursor to the white left pointing arrow's hot-spot (860) and click.

### End-of-Information

When the cursor is over a hot-spot and a mouse-over action occurs, but when clicking on the hot-spot nothing happens, the user is at the end of information for that item-of-interest. This is similar to coming to the end of a section in a book.

### Complex Item-of-Interests

Complex item-of-interests require more information to describe their location and functions. Complex item-of-interests usually perform more than one function in one replaceable part (item-of-interest). Complex items-of-interest can require an associated schematic/schematics or other types of technical information to describe them and their relationship with machine operations.

The following is an example of navigating to and from complex item-of-interests with the present embodiment. Notice in this example the user starts at Physical Appearance and Location and navigates to the complex item-of-interest. The user can also navigate to the complex item-of-interest from the OBD button, Trouble Shooting button, and/or Belting button GUI entrances.

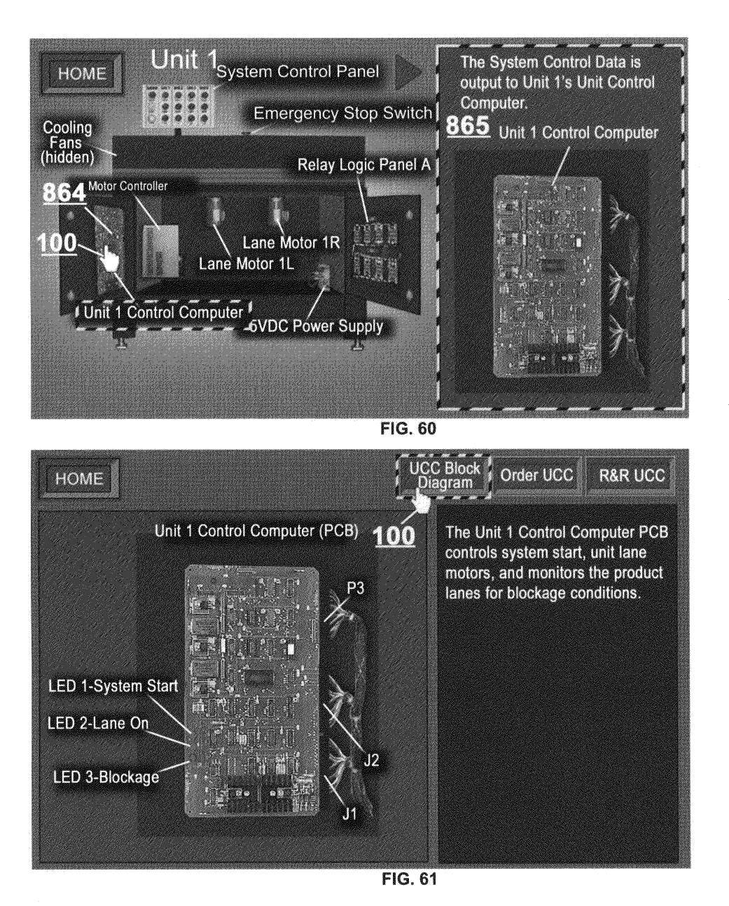

In FIG. 2 the homepage window is displayed. In FIG. 3 the user has moved the cursor (100) to Unit 1's hot-spot (861). The user can see the item-of-interest (862), in Cursor Window (863), is physically located in Unit 1. The user then clicks on the hot-spot to go to more detailed information about Unit 1, resulting in the display as depicted in FIG. 26. Once the user has moved the cursor (100) to the Unit 1 Control Computer's location hot-spot (864), the display changes as in FIG. 60. From this display the user can see the item-of-interest, the Unit 1 Control Computer, in the Cursor Window (865). The user clicks on the hot-spot to go to more detailed information about the Unit 1 Control Computer. The Unit 1 Control Computer (UCC) PCB (Printed Circuit Board) then displays as in FIG. 8. The user may then move the cursor (100) to the UCC Block Diagram button's hot-spot and click as in FIG. 61.

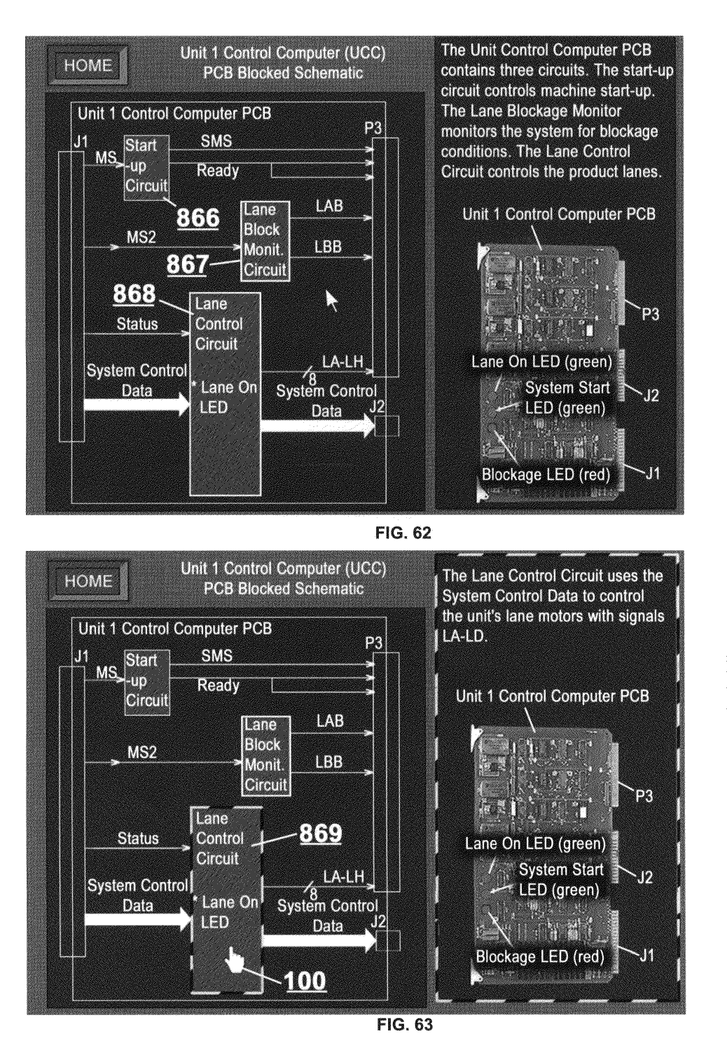

The Unit 1 Control Computer's PCB Blocked Schematic window then displays as in FIG. 62. The UCC PCB as depicted is a complex item-of-interest. Notice that the UCC PCB has three circuits Start-up (866), Lane Blockage Monitor (867), and Lane Control (868). Each of these circuits are part of a different complex circuit or function. The only thing these circuits have in common is that they reside on the same piece of hardware, the UCC PCB. To provide connectivity between the DBDs the circuits are part of and the UCC Blocked Schematic, hot-spots have been placed on the each circuit on the Blocked Schematic. When any of these hot-spots are clicked, the circuit's DBD displays. As previously discussed, the DBD has a button to navigate the user from DBD back to the blocked schematic.

As depicted in FIG. 63, the user moves the cursor (100) over the Lane Control Circuit (869) and clicks on the hot-spot. The Lane Motors Control DBD window displays as in FIG. 21. Notice the Lane Control Circuit (870) on the Unit 1 Control Computer (871). It is the same circuit that was shown on the blocked schematic, but on the DBD it has been diagrammed as a part of the system, independent of the other circuits on the UCC PCB. All the circuits on the PCB would be diagrammed in two places. All of the PCBs circuits would be diagrammed on the PCB Blocked Schematic and each of the circuits would also be diagrammed on the system or DBD diagrams.

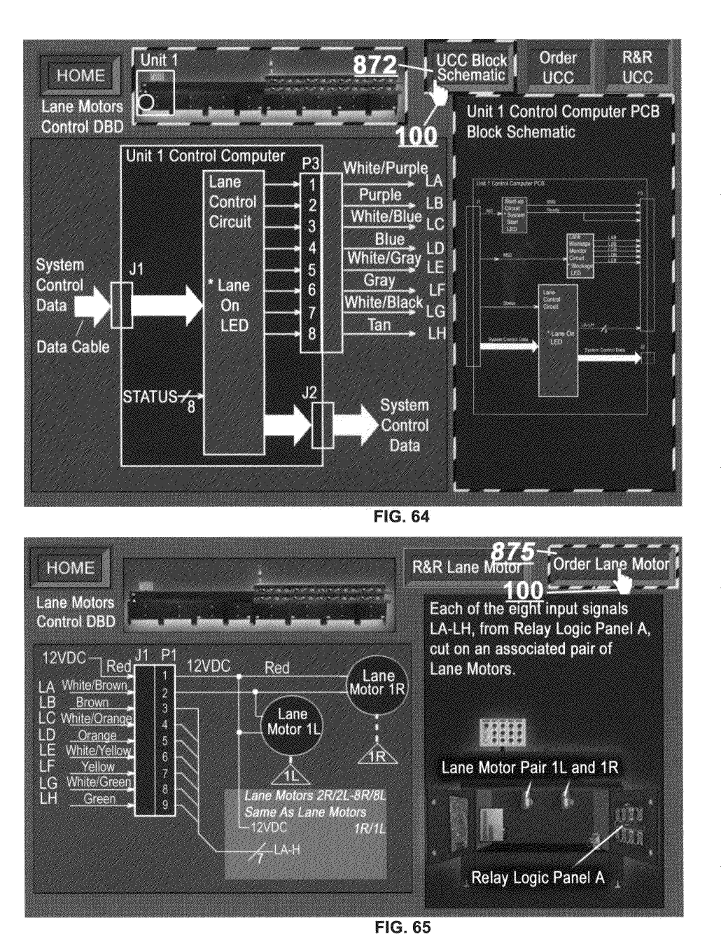

In FIG. 64 the user has moved the cursor (100) to the UCC Block Schematic button's hot-spot (872). The user clicks this button to return to the Unit 1 Control Computer PCB Blocked Schematic window. The Unit 1 Control Computer PCB Blocked Schematic displays as in FIG. 62.

### Parts Ordering

In the present embodiment the GUI may also be used to locate and order parts. The user doesn't have to know the part name or part number, just the parts location and appearance. The Management Software (MS) also records parts usage, including the location of a faulty part, that part's replacement history, etc. The MS records the parts used, time it takes to replace the part, and displays the time it should take to replace the part. The MS reports all machine information to a system database.

Consider an example in which a user has been tasked with ordering two replacement 1R Lane Motors. The user knows the location and appearance of Lane Motor 1R. The user logins in and the homepage window displays as in FIG. 2. The user is going to use appearance and location to locate the Lane Motor Order Form.

Once the user has moved the cursor (100) and clicked Unit 1's hot-spot (873) as in FIG. 25, the Unit 1 window displays as in FIG. 26. The system then provides information that helps in locating the desired part on the machine. The user may then move the cursor (100) to the Lane Motor 1R's location hot-spot (874) as In FIG. 27. After selecting this hot-spot, the user is presented with the Lane Motors Control DBD window display as in FIG. 6.

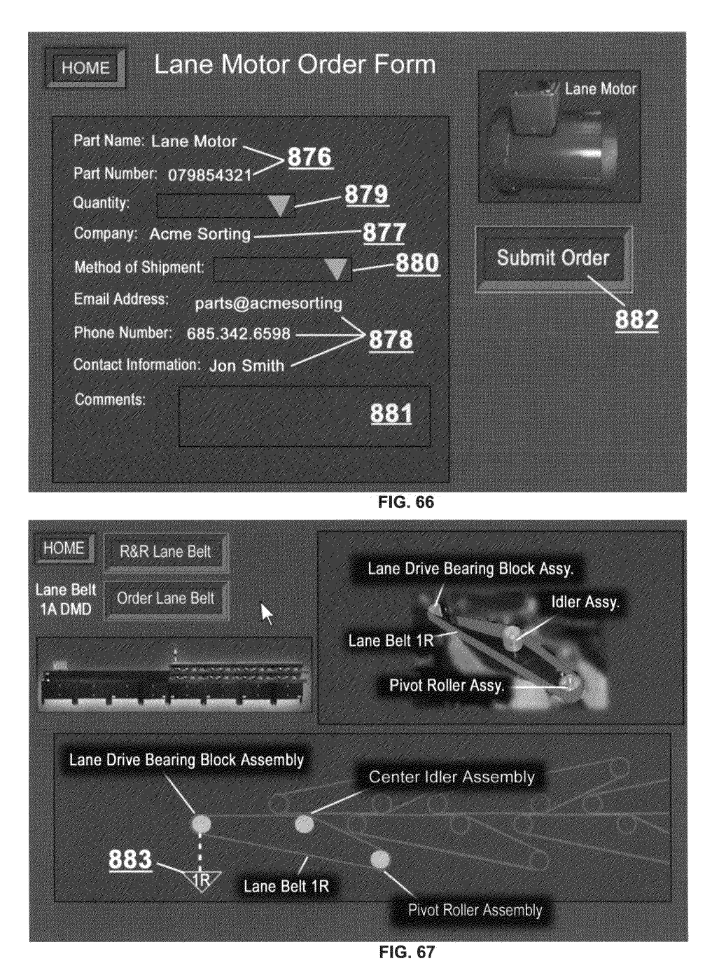

Next the user has moved the cursor (100) to the Order Lane Motor button's hot-spot (875) as depicted in FIG. 65. The user may then click on the hot-spot, which displays the Lane Motor Order Form window as depicted in FIG. 66. Many text fields (876, 877, and 878) are automatically filled out by the Management Software, but some text fields (879, 880, and 881) must be filled out by the user. Once the user fills out the required text fields he or she may select the Submit Order button's hot-spot (882) to automatically order the part. In the present embodiment the ordering information is stored in the system database and a completed order form is automatically sent to a parts fulfillment entity. A report is also generated for management and a shipping confirmation is emailed to the responsible employee.

### Electro-Mechanical Signals

Electro-mechanical signals illustrate the mechanical connectivity between electrical and mechanical items-of-interests. The types of connections can be electro-pneumatic, electro-hydraulic, electro-mechanical, mechanical-mechanical and/or any other type of connectivity. The interface of the present invention is also intuitive in processing and displaying this information.

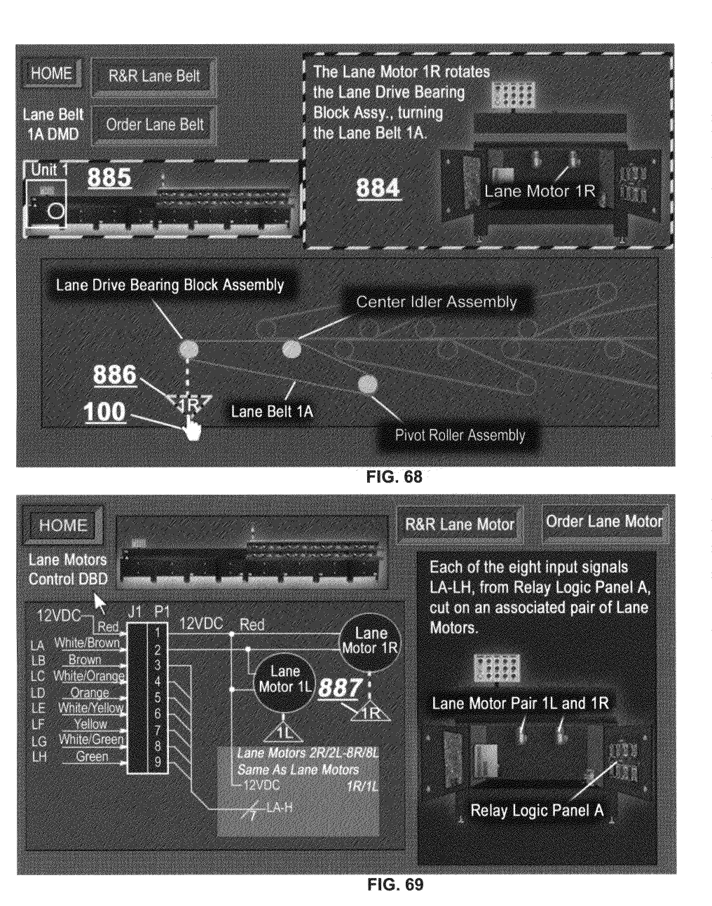

A Lane Belt 1A Detailed Mechanical Diagram (DMD) window is available as depicted in FIG. 67. As shown, the electro-mechanical signal link (883) is identified with a triangle with the reference designator of the drive item-of-interest inside the triangle, in this example 1R. The triangle points in the direction of the drive item-of-interest, which, in this case is Lane Motor 1R. In FIG. 68 the user has moved the cursor (100) over the electro-mechanical link triangle 1R's hot-spot (886) while observing the Cursor Windows (884 and 885) for detailed information. It is easy to identify where the drive element Lane Motor 1R is located in first Cursor Window (885) and what it looks like (it's appearance) in the second Cursor Window (884). The user may select the mechanical connection link to navigate to the Lane Motors Control DBD window.

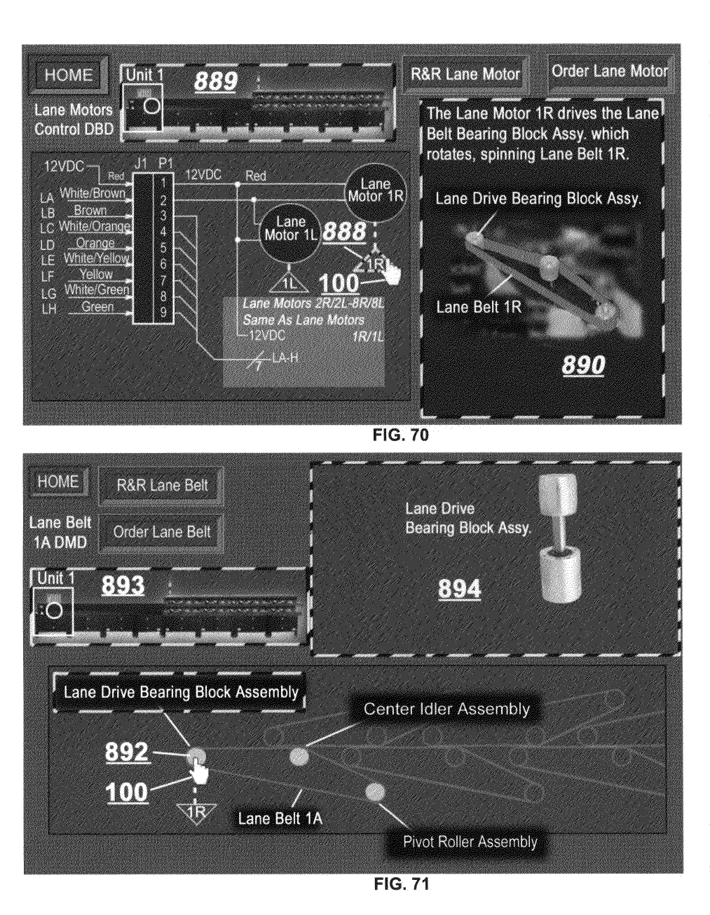

If selected, the Lane Motors Control DBD window displays as in FIG. 69. Notice, from the drawing, the mechanical link triangle 1R (887) is pointing towards the drive element Lane Motor 1R. To find out more about the mechanical connection 1R shown in FIG. 70, the user can move the cursor (100) to the mechanical signal link triangle 1R's hot-spot (888) while observing the Cursor Windows (889 and 890). It is easy to see where the driven item-of-interest is located in the first Cursor Window (889) and what it looks like (its appearance) in second Cursor Window (890). The user may then select the mechanical connection link to navigate to the Lane Belt 1A DMD window as shown in FIG. 67. To navigate back to the Detailed Lane Motors Control DBD, the user may move the cursor over the 1R hot-spot (891) and “click.”

### Mechanical Links

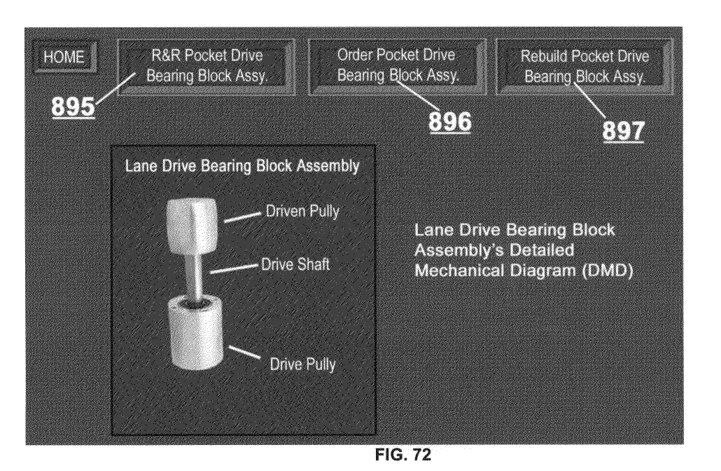

Mechanical Links illustrate the connectivity between mechanical item-of-interests and their information. Such a display is depicted in FIG. 71. In this figure, the Lane Belt 1A Detailed Mechanical Diagram (DMD) window is displayed. The user may move the cursor (100) to the Lane Drive Bearing Block Assembly's hot-spot (892) while observing Cursor first and second Cursor Windows (893—location and 894—appearance). The user may then click on the hot-spot to navigate to the Lane Drive Bearing Block Assembly's Detailed Mechanical Diagram (DMD) window as shown in FIG. 72. The DMD contains button links to R&R (Remove & Replace) (895) procedures and Rebuilding (897) procedures and an Order Form (896). The procedures offer Stop & Go Videos and Stop & Go Animations to communicate associated technical information to the user.

### Management Software

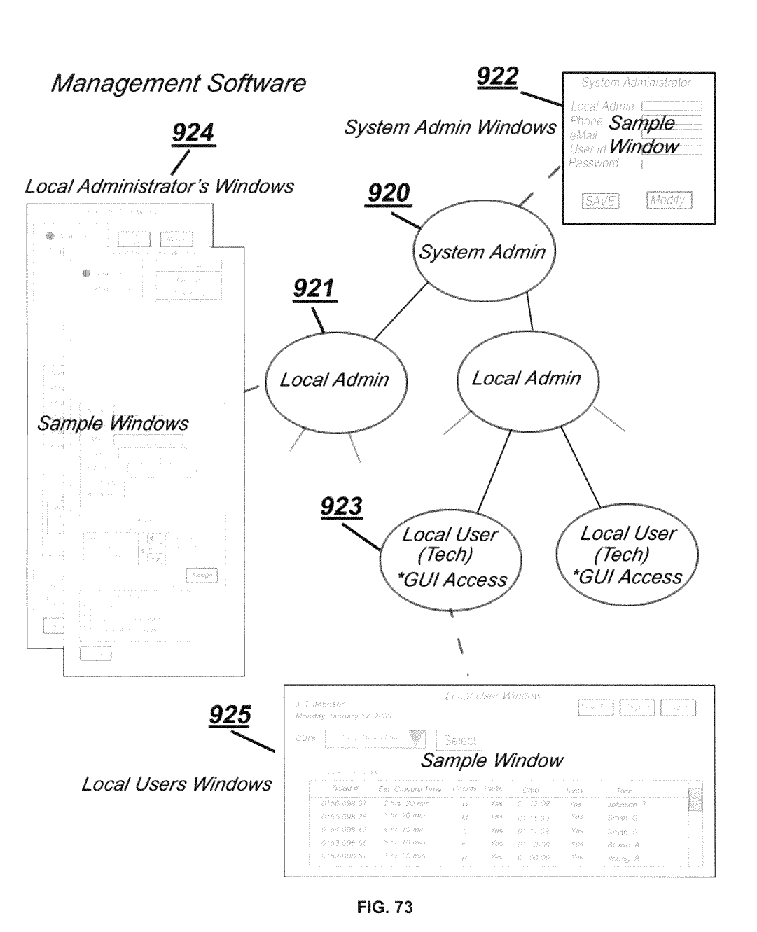

The present invention also includes Management Software (MS). The MS supports creating and using security log-ins, creating user's activity logs, generating customized user/task/time reports, parts usage trends/ordering/logs, task management, user access, and GUI access. The MS structure of this embodiment is depicted in FIG. 73. The System Administrator (920) adds Local Administrators (921) to the MS by using the System Admin window (922). The Local Administrators adds Local Users (923) to the MS by using the Local Administrator's Windows (924). The Local Administrators manage their Local Users. The Local Users access the GUI and order parts by using the Local User Windows (925). The Local Administrator assigns Job Tickets to their Local users. All the users can generate customized reports. All data is saved to a system database for logging and reporting.

### System Hardware and Software Embodiments

The present invention is designed to run as a system that utilizes one or more computing platforms capable of generating a graphical user interface (GUI). The functionality described herein may be implemented using standard programming languages that include, but are not limited to, C, C++, C#, Java, Visual Basic, VBScript, JavaScript, Pearl, Ruby, Assembly, or any other programming language capable of generating computer machine code to produce or support a graphical user interface for user interaction. One of ordinary skill will understand that any such language, or a combination, may be utilized and is within the scope of the invention.

The present embodiment may be designed to operate as a dedicated GUI that is supported by a single operating system, or may be developed using software that is portable across multiple operating systems. Further, the GUI may be implemented on a Web server using HTML code to generate the GUI to operate in a user's Web browser. Thus, the system may be accessed over a private network, the Internet, or may run on an isolated computer system.

The computing device as utilized herein may be a single computer or may consist of multiple computers. The computing device may be a general purpose computer or may be a dedicated computer. In any event, the computing device is capable of operating machine program code to provide the desired functionality. Such computing devices may utilize RISC or CISC processors, DSP, FPGA, ASIC, CPLD, or other such devices, or any combination thereof.

As used herein, a system database can be any device capable of interfacing with the computing device and capable of storing data generated by the computing device. The database device may also consist of any semiconductor or hardware volatile or non-volatile memory storage technologies or a combination of the two. For example, the GUI of the present invention may extract its operational data from a removable flash memory device that holds relevant machine maintenance and operation information. Such a system would allow rapid reconfiguration of the GUI for any number of machines. Likewise, in another embodiment, relevant machine information may be stored on a hard drive storage device or similar non-volatile storage medium. For rapid and efficient data access it is also possible to utilize volatile RAM memory as the storage medium.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

Claim 1. A method for providing a user with dynamically varying levels of operational, support, maintenance, and repair information for a machine or piece of equipment composed of a plurality of subcomponents, the method steps comprising: providing a database device capable of supplying detailed information regarding a machine, and a first computing device operably coupled with the database device and operably configured to provide a graphical user interface (GUI) capable of user interaction, the GUI providing a cursor for manipulation by a user and at least a first area and a second area for display of information detail regarding the machine, the first area and second area including one or more hot-spots for user interaction, wherein the information in the areas is related, and wherein the detail level of the related information varies between the areas; providing a first image of the machine in a first window area on the GUI wherein the first image represents a high-level image of the machine; displaying a first level of information detail related to the operation of the machine; and detecting the cursor position and varying the information displayed in the first area or the second area based upon the cursor position and, in response, displaying a second level of information detail that is greater in detail than the first level of information.

Claim 2. The method of Claim 1, the method steps further comprising: displaying additional machine information detail in response to the user selecting an area hot-spot with the cursor.

Claim 3. The method of Claim 1, the method steps further comprising: displaying a third level of information detail that is greater in detail than the second level of information, in response to the user selecting an area hot-spot with the cursor.

Claim 4. The method of Claim 1, the method steps further comprising: providing Stop-and-Go Video related to the machine information displayed.

Claim 5. The method of Claim 1, the method steps further comprising: providing Stop-and-Go Animation related to the machine information displayed.

Claim 6. The method of Claim 1, the method steps further comprising: providing an order form for automated ordering of replacement machine parts.

Claim 7. The method of Claim 1, the method steps further comprising: displaying a second image of a subcomponent of the machine in response to user selection by the cursor of an area of the first image, wherein the second image represents the subcomponent located within the user-selected area of the machine.

Claim 8. The method of Claim 7, the method steps further comprising: displaying Moving Shapes over the first image to approximate the location of the subcomponent.

Claim 9. A computer implemented interactive machine maintenance support system, the system comprising: a database device capable of providing detailed information regarding a given machine; a first computing device operably coupled with the database device and operably configured to provide a graphical user interface (GUI) capable of user interaction, the GUI comprising: a first area for displaying a first level of information detail regarding the machine, the first area including one or more hot-spots for user interaction; and a second area for displaying a second level of information detail that is greater in detail than the first level of information detail provided in the first area, wherein the second level of information is related to the first level of information, the second area including one or more hot-spots for user interaction, wherein a user may interact with a hot-spot by manipulating a cursor with respect to the first or second area hot-spots, wherein manipulation of the cursor occurs through manipulation by the user of an input device, and wherein interaction with a hot-spot in one area influences the information displayed in the other area.

Claim 10. The system of Claim 9, the GUI further comprising: a third area for displaying a third level of information detail that is greater than the second level of information, wherein the third level of information is related to the second level of information.

Claim 11. The system of Claim 9, wherein interaction with a hot-spot occurs when the cursor is placed over the hot-spot.

Claim 12. The system of Claim 9, wherein interaction with a hot-spot occurs when the cursor is placed over the hot-spot and the user selects the hot-spot by actuating a switch on the input device.

Claim 13. The system of Claim 9, wherein the information detail comprises multimedia.

Claim 14. The system of Claim 9, wherein the second area is capable of providing Stop-and-Go Video or Stop-and-Go Animation.

Claim 15. The system of Claim 9, wherein the second level of information detail comprises an electrical circuit schematic, and wherein related subcomponents of the electrical circuit schematic are grouped for functional representation in the second area display through use of differing colors, and wherein the colors change in relation to the troubleshooting steps performed.

Claim 16. The system of Claim 9, the GUI further comprising: an order feature for allowing the user to order machine repair parts based upon the repair information provided by the system.

Claim 17. The system of Claim 9, wherein the first level of information detail represents an Overall Block Diagram of a subcomponent of the machine, the second level of information detail represents an Intermediate Block Diagram of the subcomponent of the machine, and the third level of information represents a Detailed Block Diagram of the subcomponent of the machine.

Claim 18. The system of Claim 9, the system further comprising: a first image representative of the machine, wherein the first image changes in response to the user's interactions with either the first or second area hot-spots.

Claim 19. The system of Claim 18, wherein Moving Shapes appear on the first image in response to the user's interactions with the first or second area hot-spots.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

1. A method for providing a user with dynamically varying levels of operational, support, maintenance, and repair information for a machine or piece of equipment composed of a plurality of subcomponents, the method steps comprising: providing a database device capable of supplying detailed information regarding a machine, and a first computing device operably coupled with the database device and operably configured to provide a graphical user interface (GUI) capable of user interaction, the Gill providing a cursor for manipulation by a user and at least a first area and a second area for display of information detail regarding the machine, the first area and second area including one or more hot-spots for user interaction, wherein the information in the areas is related, and wherein the detail level of the related information varies between the areas; providing a first image of the machine in a first window area on the GUI wherein the first image represents a high-level image of the machine; displaying a first level of information detail related to the operation of the machine; and detecting the cursor position and varying the information displayed in the first area or the second area based upon the cursor position and, in response, displaying a second level of information detail that is greater in detail than the first level of information.

2. The method of claim 1, the method steps further comprising: displaying additional machine information detail in response to the user selecting an area hot-spot with the cursor.

3. The method of claim 1, the method steps further comprising: displaying a third level of information detail that is greater in detail than the second level of information, in response to the user selecting an area hot-spot with the cursor.

4. The method of claim 1, the method steps further comprising: providing Stop-and-Go Video related to the machine information displayed.

5. The method of claim 1, the method steps further comprising: providing Stop-and-Go Animation related to the machine information displayed.

6. The method of claim 1, the method steps further comprising: providing an order form for automated ordering of replacement machine parts.

7. The method of claim 1, the method steps further comprising: displaying a second image of a subcomponent of the machine in response to user selection by the cursor of an area of the first image, wherein the second image represents the subcomponent located within the user-selected area of the machine.

8. The method of claim 7, the method steps further comprising: displaying Moving Shapes over the first image to approximate the location of the subcomponent.

9. A computer implemented interactive machine maintenance support system, the system comprising: a database device capable of providing detailed information regarding a given machine; a first computing device operably coupled with the database device and operably configured to provide a graphical user interface (GUJ) capable of user interaction, the GUJ comprising: a first area for displaying a first level of information detail regarding the machine, the first area including one or more hot-spots for user interaction; and a second area for displaying a second level of information detail that is greater in detail than the first level of information detail provided in the first area, wherein the second level of information is related to the first level of information, the second area including one or more hot-spots for user interaction, wherein a user may interact with a hot-spot by manipulating a cursor with respect to the first or second area hot-spots, wherein manipulation of the cursor occurs through manipulation by the user of an input device, and wherein interaction with a hot-spot in one area influences the information displayed in the other area.

10. The system of claim 9, the GUI further comprising: a third area for displaying a third level of information detail that is greater than the second level of information, wherein the third level of information is related to the second level of information.

11. The system of claim 9, wherein interaction with a hot-spot occurs when the cursor is placed over the hot-spot.

12. The system of claim 9, wherein interaction with a hot-spot occurs when the cursor is placed over the hot-spot and the user selects the hot-spot by actuating a switch on the input device.

13. The system of claim 9, wherein the information detail comprises multimedia.

14. The system of claim 9, wherein the second area is capable of providing Stop-and-Go Video or Stop-and-Go Animation.

15. The system of claim 9, wherein the second level of information detail comprises an electrical circuit schematic, and wherein related subcomponents of the electrical circuit schematic are grouped for functional representation in the second area display through use of differing colors, and wherein the colors change in relation to the troubleshooting steps performed.

16. The system of claim 9, the GUI further comprising: an order feature for allowing the user to order machine repair parts based upon the repair information provided by the system.

17. The system of claim 9, wherein the first level of information detail represents an Overall Block Diagram of a subcomponent of the machine, the second level of information detail represents an Intermediate Block Diagram of the subcomponent of the machine, and the third level of information represents a Detailed Block Diagram of the subcomponent of the machine.

18. The system of claim 9, the system further comprising: a first image representative of the machine, wherein the first image changes in response to the user's interactions with either the first or second area hot-spots.

19. The system of claim 18, wherein Moving Shapes appear on the first image in response to the user's interactions with the first or second area hot-spots.
